SEQUENCE LISTING (5 sequences)

SEQ ID NO: 1 - protein, 231 aa, Homo sapiens
EVQLVESGGGLVQPGGSLRLSCAASGYTFTNYGMNWVRQAPGKGLEWVGWINTYTGEPTYAADFKRRFTFSLDTSKSTAYLQMNSLRAEDTAVYYCAKYPHYYGSSHWYFDVWGQGTLVTVSSASTKGPSVFPLAPSSKSTSGGTAALGCLVKDYFPEPVTVSWNSGALTSGVHTFPAVLQSSGLYSLSSVVTVPSSSLGTQTYICNVNHKPSNTKVDKKVEPKSCDKTHT

SEQ ID NO: 2 - protein, 214 aa, Homo sapiens
DIQMTQSPSSLSASVGDRVTITCSASQDISNYLNWYQQKPGKAPKVLIYFTSSLHSGVPSRFSGSGSGTDFTLTISSLQPEDFATYYCQQYSTVPWTFGQGTKVEIKRTVAAPSVFIFPPSDEQLKSGTASVVCLLNNFYPREAKVQWKVDNALQSGNSQESVTEQDSKDSTYSLSSTLTLSKADYEKHKVYACEVTHQGLSSPVTKSFNRGEC

SEQ ID NO: 3 - protein, 22 aa, Escherichia coli
MKYLLPTAAAGLLLLAAQPAMA

SEQ ID NO: 4 - DNA, 25 bp, Escherichia coli
ctagttaattaaaggaggagcaggg

SEQ ID NO: 5 - DNA, 25 bp, Escherichia coli
ctaggcggccgcaggaggagcaggg

(19) United States
(12) Patent Application Publication
(10) Pub. No.: US 2012/0258866 A1
(43) Pub. Date: Oct. 11, 2012

(54) MULTI-DIMENSIONAL SELECTION OF PROTEIN MUTANTS USING HIGH THROUGHPUT SEQUENCE ANALYSIS

(75) Inventor: Robert DuBridge, Belmont, CA (US)

(73) Assignee: FULL SPECTRUM GENETICS, INC., South San Francisco, CA (US)

(21) Appl. No.: 13/424,383

(22) Filed: Mar. 20, 2012

Related U.S. Application Data
(63) Continuation-in-part of application No. 13/236,651, filed on Sep. 20, 2011.
(60) Provisional application No. 61/472,164, filed on Apr. 5, 2011.
(60) Provisional application No. 61/510,876, filed on Jul. 22, 2011.

(51) Int. Cl. C40B 20/00

(52) U.S. Cl. 506/2

(57) ABSTRACT

The invention is directed to methods for simultaneously improving a plurality of characteristics of a protein binding compound. In accordance with one aspect of the invention, a focused library of nucleic acid-encoded variants is produced and separately exposed to a plurality of reaction conditions each designed to segregate the library variants according to a different characteristic of interest, such as affinity, stability, cross-reactivity, or the like. In various embodiments, such reactions may be conducted pair-wise to simultaneously obtain improvements in two characteristics or they may be conducted three-at-a-time to simultaneously obtain improvements in three characteristics. In each case, nucleotide sequences encoding library variants segregated into improved subsets are determined, after which sequences occurring in two or more subsets are identified to obtain library variants with two or more improved characteristics.

This application is a continuation-in-part of U.S. application Ser. No. 13/236,651 filed 20 Sep. 2011 and claims priority from U.S. provisional application Ser. No. 61/472,164 filed 5 Apr. 2011 and Ser. No. 61/510,876 filed 22 Jul. 2011, each of which is incorporated herein by reference in its entirety.

### BACKGROUND

Over the past two decades, therapeutic antibodies have become important treatment options for cancers, inflammatory diseases and other conditions, Nelson et al, Nature Reviews Drug Discovery, 9(10): 767-774 (2010). Next generation therapeutic antibodies are being engineered and developed that have a host of performance improvements, including modified affinities, increased stability, reduced immunogenicity, greater solubility, and the like, e.g. Igawa et al, mAbs, 3(3): 243-252 (2011); Bostrom et al, Science, 323: 1610-1614 (2009). Despite striking progress, making such improvements is still a costly and time-consuming endeavor, particularly because key characteristics such as immunogenicity, solubility, stability, manufacturability, and the like, depend on primary amino acid sequence and are often interrelated, so that an improvement in one characteristic can very easily have a negative impact on the other characteristics, Igawa et al (cited above).

In view of the above, it would be highly advantageous for therapeutic antibody development if techniques were available that permitted convenient multi-dimensional evaluation of improvement candidates, so that candidates having improvements in all characteristics of interest and those that display mixed performance results could be efficiently identified.

### SUMMARY OF THE INVENTION

The present invention is directed to methods for measuring in parallel the effects of mutations on a plurality of protein characteristics, such as relative affinity to a target molecule, expression level in a selected host organism, stability, cross reactivity, and the like. Aspects of the present invention are exemplified in a number of implementations and applications, some of which are summarized below and throughout the specification.

In one aspect the invention is directed to a method of selecting binding compounds having a plurality of predetermined performance characteristics comprising the steps of: (a) separately exposing a library of candidate binding compounds to a plurality of reaction conditions such that candidate binding compounds of the library are segregated into subsets by each of the reaction conditions and such that segregated candidate binding compounds of at least one subset of each reaction condition meet a predetermined performance characteristic, each candidate binding compound of the library being encoded by a nucleotide sequence; (b) determining for each reaction condition nucleotide sequences of candidate binding compounds of at least one subset containing candidate binding compounds meeting a predetermined performance characteristic; and (c) selecting binding compounds having the plurality of predetermined performance characteristics by identifying candidate binding compounds whose nucleotide sequences are determined in at least one subset of each of the plurality of reaction conditions.

In another aspect the invention is directed to a method of determining binding compound mutants having increased expression in a host organism, comprising the steps of: (a) reacting under binding conditions one or more ligands with a library of binding compounds comprising a reference binding compound and mutants thereof, the reference binding compound and each mutant thereof being encoded by a nucleotide sequence; (b) determining the nucleotide sequences of binding compounds forming complexes with the one or more ligands to obtain a relative affinity for each thereof based on a number of nucleotide sequences enumerated for each such binding compound, respectively, each relative affinity having a coefficient of variation of ten percent or less; (c) measuring expression of an internal standard and each of the library of binding compounds on a surface of a host organism so that expression of each binding compound can be compared to that of the internal standard; (d) determining the nucleotide sequences of binding compounds being expressed on the surface of the host organism at a higher level than that of the reference binding compound; and (e) selecting mutants of the reference binding compound that have a relative affinity equal to or greater than that of the reference binding compound and an expression level in the host organism greater than that of the reference binding compound.

In another aspect, the invention includes a method of determining binding compound mutants having increased stability and expression in a host organism comprising the steps of: (a) reacting under binding conditions one or more ligands with an untreated library of binding compounds comprising a reference binding compound and mutants thereof, the reference binding compound and each mutant thereof being encoded by a nucleotide sequence; (b) determining the nucleotide sequences of binding compounds forming complexes with the one or more ligands to obtain a relative affinity for each thereof based on a number of nucleotide sequences enumerated for each such binding compound, respectively, each relative affinity having a coefficient of variation of ten percent or less; (c) treating the untreated library with a destabilizing agent to form a treated library; (d) reacting under binding conditions the one or more ligands with the treated library and determining the nucleotide sequences of binding compounds forming complexes with the one or more ligands to obtain a relative affinity for each thereof based on a number of nucleotide sequences enumerated for each such binding compound, respectively, each relative affinity having a coefficient of variation of ten percent or less; (e) measuring expression of an internal standard and each of the library of binding compounds on a surface of a host organism so that expression of each binding compound can be compared to that of the internal standard; (f) determining the nucleotide sequences of binding compounds being expressed on the surface of the host organism at a higher level than that of the reference binding compound; and (g) selecting mutants of the reference binding compound that have a relative affinity equal to or greater than that of the reference binding compound in the untreated library, an expression level in the host organism greater than that of the reference binding compound, and a relative affinity equal to or greater than that of the reference binding compound in the treated library.

These above-characterized aspects, as well as other aspects, of the present invention are exemplified in a number of illustrated implementations and applications, some of which are shown in the figures and characterized in the claims section that follows. However, the above summary is not intended to describe each illustrated embodiment or every implementation of the present invention.

### BRIEF DESCRIPTIONS OF THE DRAWINGS

FIG. 1A diagrammatically illustrates the general concept of the invention.

FIG. 1B is a diagram of a work flow for one embodiment of the invention in which nucleic acids encoding binder and non-binders are sequenced.

FIG. 1C is a diagram of a work flow for another embodiment of the invention in which nucleic acids encoding a library of binding compounds is sequenced and nucleic acids encoding members of the library that bind to targets is sequenced.

FIGS. 2A-2B show exemplary frequency distributions of encoding nucleic acids from candidate binding compounds that form complexes target antigen (FIG. 2A) and those that are free (FIG. 2B).

FIGS. 2C-2D show orderings of binding compounds with respect to affinity based on the data of FIGS. 2A and 2B.

FIG. 2E illustrates a “heat map” representation of affinity data generated by the method of the invention.

FIG. 3 is a diagram of an immunoglobulin G molecule and its constituent regions.

FIG. 4 illustrates data from FACS analysis of a mammalian expression host expressing members of a library of binding compounds together with an internal standard linked together on an expression vector by an IRES element.

FIG. 5 is a genetic map of a phagemid vector with which compound libraries of the invention may be made in one embodiment.

FIG. 6 is a genetic map of an SV40-based mammalian expression vector for surface expression of library variants (in IgG format) and low-affinity nerve growth factor receptor (LNGFR) as an internal standard.

FIG. 7 is a genetic map of an EBV-based mammalian expression vector for surface expression of library variants (in IgG format) and low-affinity nerve growth factor receptor (LNGFR) as an internal standard.

FIG. 8 is a genetic map of a yeast expression vector for surface expression of library variants (in IgG format) and low-affinity nerve growth factor receptor (LNGFR) as an internal standard.

### DETAILED DESCRIPTION OF THE INVENTION

The practice of the present invention may employ, unless otherwise indicated, conventional techniques and descriptions of organic chemistry, molecular biology (including recombinant techniques), cell biology, and biochemistry, which are within the skill of the art. Such conventional techniques include, but are not limited to, preparation of synthetic polynucleotides, monoclonal antibodies, antibody display systems, nucleic acid sequencing and analysis, and the like. Specific illustrations of suitable techniques can be had by reference to the example herein below. However, other equivalent conventional procedures can, of course, also be used. Such conventional techniques and descriptions can be found in standard laboratory manuals such as Genome Analysis: A Laboratory Manual Series (Vols. I-IV); PCR Primer: A Laboratory Manual; Phage Display: A Laboratory Manual; and Molecular Cloning: A Laboratory Manual (all from Cold Spring Harbor Laboratory Press); Sidhu, editor, Phage Display in Biotechnology and Drug Discovery (CRC Press, 2005); Lutz and Bornscheuer, Editors, Protein Engineering Handbook (Wiley-VCH, 2009); Hermanson, Bioconjugate Techniques, Second Edition (Academic Press, 2008); and the like.

In one aspect the invention provides methods for improving or modifying in parallel a plurality of characteristics of a nucleic acid-encoded protein binding compound, such as an antibody binding compound. Any characteristic that can be measured or determined in a selective reaction may be improved in parallel with other characteristics also having selective assays. As used herein, “selective reaction” means a test or assay that permits physical or chemical separation, segregation, or recovery of variant proteins based on their performance or modification in such assay or test. Selective reactions include, but are not limited to, assays for affinity to a target molecule, stability, cross-reactivity, expression level, and the like. In accordance with one aspect of the invention, a library of nucleic acid-encoded binding compounds is subjected in parallel to a plurality selective reactions such that in each reaction individual binding compounds of the library that have a desired characteristic (or a desired value of a characteristic) are separated and identified by high throughput DNA sequencing.

Of particular interest are variants of a known or reference binding compound which have approximately the same (or in some embodiments better) affinity as the reference binding compound to a target molecule or epitope but which have superior performance in another selection reaction of interest, such stability assays, cross-reactivity assays, or the like. Libraries of such variants are important aspects of some embodiments of the invention. As discussed more fully below, sizes of such libraries are selected so that values of properties of interest, such as the relative affinities, expression levels, stability, cross-reactivity, and the like, of the variants (also referred to herein as candidate binding compounds) may be determined with coefficients of variation (CV) ten percent (10%) or less, or in some embodiments, with CVs of five percent (5%) or less. Typically such libraries have sizes in the range of from a thousand (1000) members to a few tens of thousands members (e.g. 10,000 members). Importantly the focused library of variants allows values of characteristics, such as relative affinity, stability, cross-reactivity, and the like, to be measured for each variant with low coefficients of variation, allowing accurate comparisons to reference binding compounds.

Embodiments of special interest include those for which variants of a reference compound are selected to have (a) equivalent affinity to a target as the reference compound and (b) higher expression levels in a selected expression organism, such as a mammalian host cell, yeast host cell, bacterial host cell, insect host cell, or the like. Additional embodiments of special interest include those for which variants of a reference compound are selected to have (a) equivalent affinity to a target as the reference compound and (b) greater stability. Further embodiments of special interest include those for which variants of a reference compound are selected to have (a) equivalent affinity to a target as the reference compound and (b) less cross-reactivity with a selected set of compounds. Yet more embodiments of interest include those for which variants of a reference compound are selected to have (a) equivalent affinity to a target as the reference compound and (b) greater cross-reactivity with one or more selected compounds. For each of the above groups of embodiments, variants may be selected with greater affinity to a target in addition to being selected for improvements or modifications of the other characteristics.

In accordance with the invention, antibody binding compounds may be in different formats for different selective reactions. In particular, in one embodiment, relative affinities are assessed using an Fab antibody binding compound format displayed on phage whereas other characteristics, such as, stability, expression, cross-reactivity, and the like, are assessed using an IgG format. Transition between different formats is readily carried out using conventional molecular biology techniques to excise framework and CDR regions from a phage genome and inserting them into an appropriate vector for expressing the IgG format.

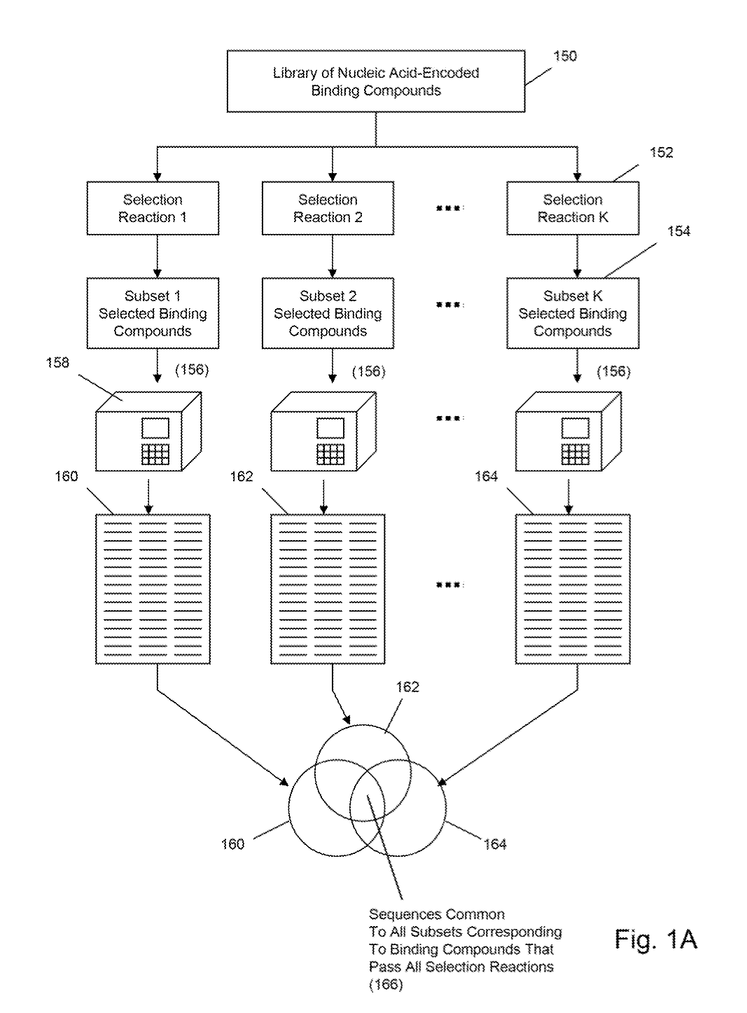

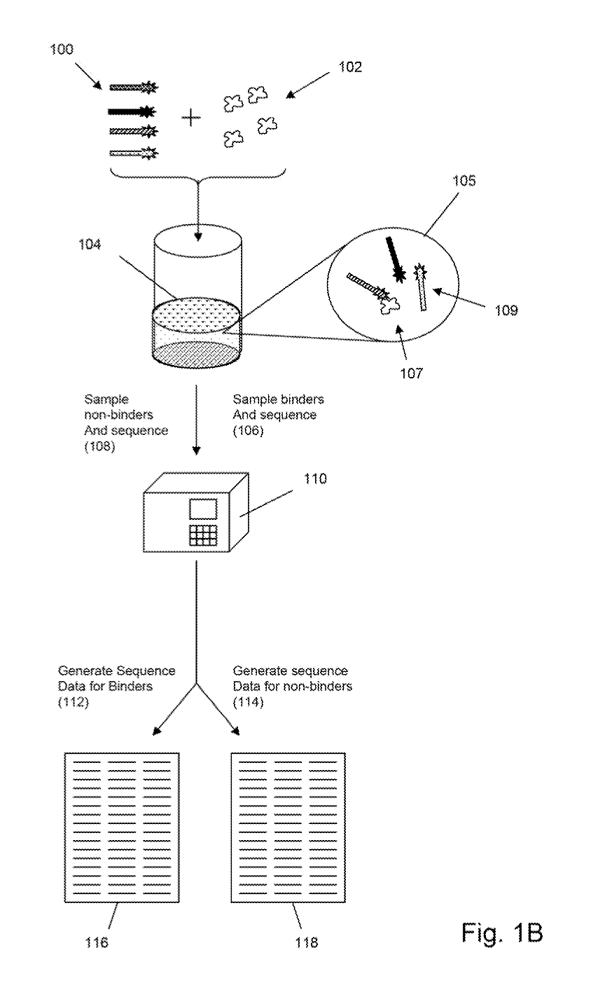

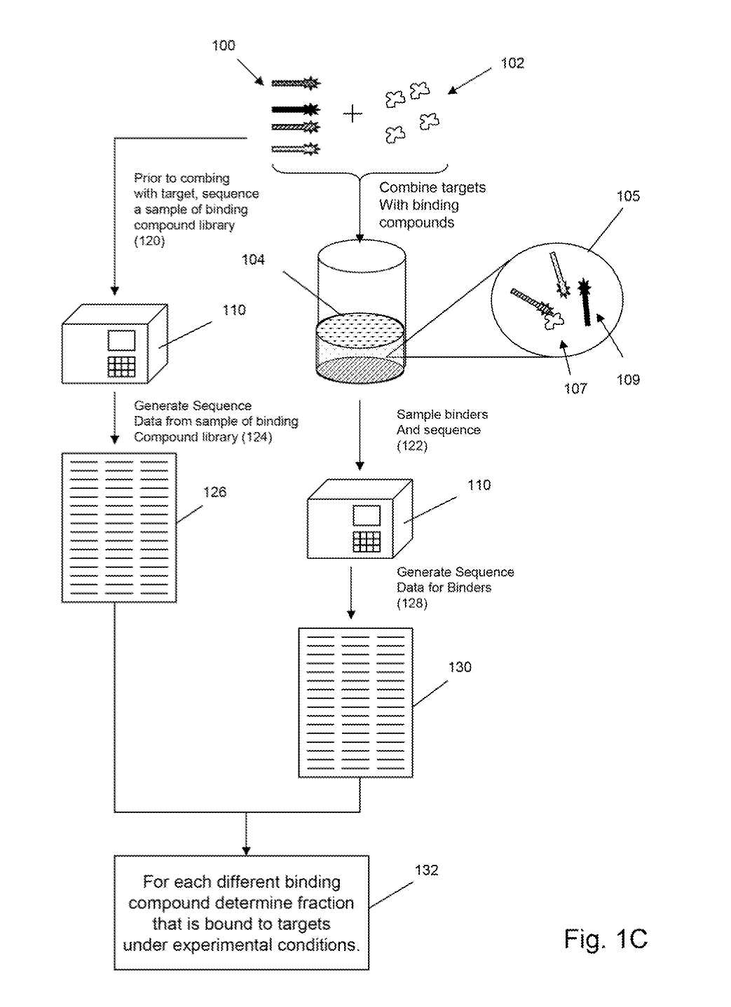

The above embodiments are illustrated in FIG. 1A. Members of the same library (150) of nucleic acid-encoded binding compounds are subjected to a plurality of selective reactions (152) that relate to a plurality of characteristics of interest, such as, relative affinity, stability, cross-reactivity, expression level, and the like. As a result of the selection reactions, different subsets (154) of library (150) are obtained and their encoding nucleic acids are sequenced, e.g. with a conventional high throughput DNA sequencer (158), to give sequence data (160), (162), and (164) for subsets 1, 2, . . . K, respectively. Variants (or candidate binding compounds) whose encoding sequences appear in the sequence data of all the subsets (that is, those in the intersection (166) of the sequence data sets) are the desired variants or candidate binding compounds.

### Additional Embodiments

Additional embodiments of the invention include the following; A method of increasing expression of a selected nucleic acid-encoded binding compound in a host organism without loss of affinity, comprising the steps of: (a) reacting under binding conditions one or more ligands with a reference binding compound and a library of candidate binding compounds, the reference binding compound and each candidate binding compound being encoded by a nucleotide sequence; (b) determining the nucleotide sequences of the candidate binding compounds forming complexes with the one or more ligands and determining for each such candidate binding compound a relative affinity from a number of nucleotide sequences of each binding compound forming a complex to its total number in the library; (c) determining for each candidate binding compound a ratio of a frequency of nucleotide sequences of binding compounds forming a complex to its total frequency in the library; (d) selecting at least one candidate binding compound from a subset of candidate binding compounds (i) whose ratio is equal to or greater than that of the selected nucleic acid-encoded binding compound (that is, the reference binding compound) and (ii) whose encoding nucleic acid encodes at least one amino acid residue different from that of the reference binding compound and increases a level of expression of such candidate binding compound in the host organism relative to that of the reference binding compound. In one embodiment, the host organism is a mammalian cell having a surface membrane and each of the candidate binding compounds is an antibody or a fragment thereof anchored in the surface membrane of the mammalian cell by a transmembrane domain.

In a further embodiment, an expression standard (that is, an internal standard) having a transmembrane domain the same as that of said candidate binding compound is expressed on said surface membrane of the mammalian cell and the level of expression of said candidate binding compound in a mammalian cell is indicated by relative amounts of said candidate binding compound and the expression standard in said surface membrane of such mammalian cell. For example, expression levels of candidate binding compounds of different host organism may be compared by comparing the values determined by dividing the observed expression level of the candidate binding compound on a particular host cell (for example, the magnitude of a fluorescence measurement made with a FACS instrument) by the observed expression level of the internal standard of the same host cell. In another embodiment, the above step of selecting includes labeling said candidate binding compound on said mammalian cell by a first label capable of generating a first signal and labeling said expression standard on said same mammalian cell by a second label capable of generating a second signal. In such case, the level of expression of said mammalian cell is indicated by a relative magnitude of the first signal to the second signal. In a further embodiment, the first and second signals are distinct fluorescent signals that are measured by a flow cytometer, or in particular a FACS instrument so that host cells generating a signal of interest may be sorted or isolated for further analysis.

### Relative Affinities

FIG. 1B illustrates a workflow of one process for determining relative affinities of binding compounds of a library to a target molecule. A library (100) of nucleic acid-encoded binding compounds, such as phage displayed antibodies, is combined with antigen (102) in reaction mixture (104) so that a binding equilibrium is established among the compounds. In one aspect, nucleic acid-encoded binding compounds are present in equimolar concentrations. Components of the reaction mixture, in addition to the binding compounds and antigen, may vary widely. In one aspect, conventional conditions for antibody-antigen binding are used, e.g. physiological salts at a neutral, or near neutral, pH using a conventional buffer, such as a phosphate buffer. Within the mixture (illustrated by blow-up 105) for each binding compound a fraction will form complexes with antigen (107) and a fraction will remain free (109).

In accordance with the invention, a sample of free binding compounds is taken and a sample of antigen-binding compound complexes is taken. For clarity, in some embodiments, such as those using binding compounds displayed on phages, or the like, a sample of free binding compounds means a sample of free phage expressing a binding compound. (Typically free phage will comprise both phage expressing binding compounds that do not bind antigen and phage that simply fail to express any binding compound. The former, that is, free phage expressing binding compound, are readily isolated or separated from phage not expressing binding compound by using conventional techniques, such as separation with anti-constant region antibodies, anti-peptide tag antibodies, e.g. a myc tag or polyhistidine tag (engineered into binding compounds), or like techniques). The two populations are conveniently sampled by using conventional techniques for manipulating proteins or antigens, e.g. Wild, editor, The Immunoassay Handbook, 3° Edition (Elsevier, 2008).

Usually, the antigen is immobilized, or is capable of being immobilized, for example, by direct adsorption to a solid support, such as an assay plate, microtiter well, or the like; or it is indirectly immobilized via a capture antibody that has been immobilized on such a support. For example, antigen may be linked to a solid support, such as magnetic beads, microtiter wells, or the like, or antigen may be labeled with a capture moiety, such as biotin, which permits binding compounds that form complexes to be isolated, e.g. with streptavidin coated magnetic beads, after a binding reaction has reached equilibrium conditions. Nucleic acids encoding the binding compounds forming complexes (i.e. binders) are extracted (106) and sequenced; likewise, nucleic acids encoding the sample of free binding compounds are extracted (108) and sequenced. In order to obtain reliable statistics on the proportion of binders and non-binders the respective samples must be sufficiently large to avoid aberrant results due to sampling error. The appropriate sample size depends at least (i) on the degree of reliability desired in determining the proportions of each binding compound bound or unbound, and (ii) the size of the library of different nucleic acid-encoded binding compounds. Unlike conventional libraries of binding compounds, where maximal diversity is sought, in some embodiments of the present invention, libraries of limited size are employed so that reliable statistics on the binding characteristic of each binding compound can be readily obtained. The size of a library for use with the invention depends on how many residues are varied in the library members, or candidate binding compounds; in other words, the size depends on the number of amino acid positions where amino acids are varied and the number of different amino acids that are substituted in at each such position.

For antibodies, varying the amino acids occupying each amino acid position one at a time in a collection of six complementary determining regions (CDRs) leads to about 1600-2200 library members (where “library” here is in reference to the encoded binding compounds, as opposed to the nucleic acids that are translated into amino acids, which of course will be more numerous because of the degeneracy of the genetic code). (FIG. 3 illustrates CDRs (black regions, 300) of heavy chain variable region (304 and indicated as 303 in the right hand heavy chain) and CDRs (302) of light chain variable region (306 and indicated as 305 in the right hand light chain) of antibody (308), which has Fab fragment encompassed by dashed rectangle (311). “Scaffold” or “framework” portions (310) surrounding the CDRs are shown on projection (309) of light chain variable region (305)). In some embodiments of the invention, samples of binders and non-binders for sequencing include many times this number of candidate binding compounds. In some embodiments, sample sizes are in the range of about 5 times or more times the library size. In some embodiments, sample sizes are in the range of from about 5 to 100 times the library size. For a 2000 member library of candidate binding compounds, a sample size of in, the range of 10⁴-2×10⁵ may be used, for example. For a library containing about 2.3×10⁴ members (e.g., amino acids of 6 CDRs varied two at a time), a sample size in the range of from 1.1×10⁵ to 2.3×10⁶ may be used. In some embodiments, nucleic acid sequences from such samples are further amplified in the course of sequence analysis. For example, if a Solexa-based sequencer is employed, primer binding sites are attached to sequences from such samples in a PCR which allows bridge PCR for forming clusters on a solid phase surface, which are analyzed by the Solexa-based sequencing chemistry. Preferably, multiple copies (e.g. ≧10 copies) of each sequence from such samples are analyzed to ensure reliable sequence determination. Thus, if a sample size of 10⁴ to 2×10⁵ is used then for Solexa-based sequencing, or equivalent technology, at least 10⁵ to 2×10⁶ clusters are formed, or sequence reads obtained, for data analysis; or if a sample size of 10⁵-10⁶ is used then for Solexa-based sequencing, or equivalent technology, at least 10⁶-10⁷ clusters are formed, or sequence reads obtained, for data analysis. In some embodiments, sufficiently large samples are taken so that the measured frequencies have P-values of 0.1 or less, or P-values of 0.05 or less, or P-values of 0.002 or less. In alternative embodiments, nucleic acids encoding scaffold regions may also be used to generate library members either by selective amino acid substitutions, additions, and/or deletions, or by substitution of scaffolds or frameworks from different antibodies, e.g. from different individuals.

FIG. 1C illustrates diagrammatically a work flow of an alternative embodiment for measuring the binding strengths of candidate nucleic acid-encoded binding compounds. Prior to forming reaction mixture (104) with nucleic acid-encoded binding compounds (100) and target molecules (102), a sample of the binding compound library is taken and its members' encoding nucleic acids are sequenced (120), using high throughput sequencing device (110). Hosts expressing binding compounds are readily separated from non-expressing hosts using antibodies specific for constant regions, e.g. goat anti-kappa chain antibody for isolating phage expressing human Fab fragments, as discussed more fully below. As mentioned above, the sample is large enough to ensure that all of the different encoding nucleic acids of the candidate binding compounds are determined with high probability. The output of such sequencing (124) is a table of sequence reads for binding compound library (126). In one embodiment, where equimolar amounts of binding compounds are added to reaction mixture (104), the number of sequence reads for each different binding compound is substantially the same. After such sample is taken, reaction mixture (104) is formed and allowed to reach an equilibrium condition with respect to free and bound binding compound, after which a sample is taken (122) of only those candidate binding compounds that are bound to target (i.e. only binders are sampled). The sequences of the encoding nucleic acids of such binders are then determined (128) using a conventional high throughput sequencing device (110) to give a table of sequence reads (130) of the encoding nucleic acids of the binders. The data in Tables (126) and (130) are then used to calculate (132) the fraction or ratio of each candidate binding compound that is bound to target in reaction mixture (104). In one embodiment, such a fraction or ratio may be calculated by simply enumerating the sequence reads of each candidate binding compound in each Table and then taking the ratio of the numbers. As exemplified below, conventional techniques are used to determine relative amounts of candidate bind compounds to be combined with the one or more ligands in binding reactions so that the above sequence information can be obtained and converted into measures related to affinities.

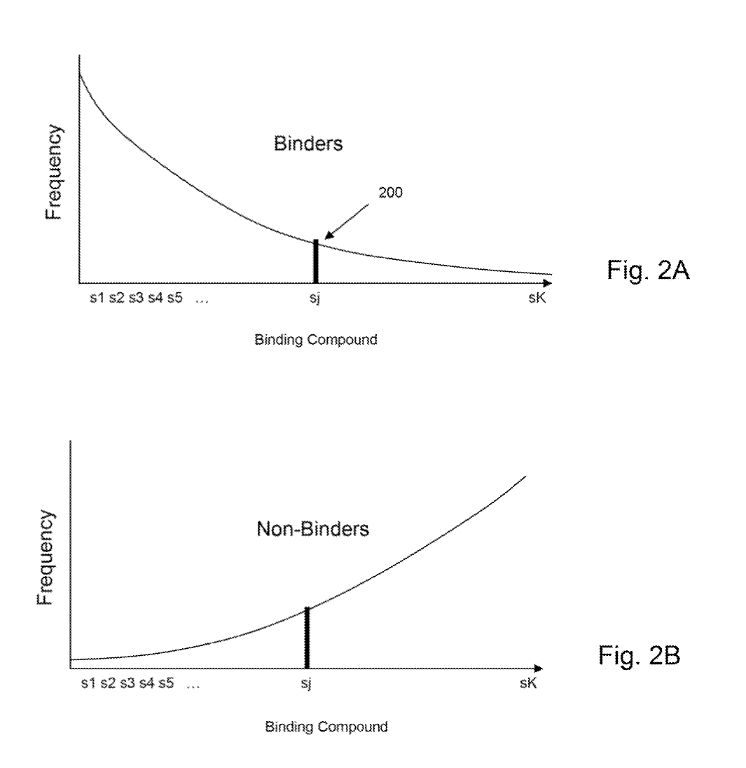

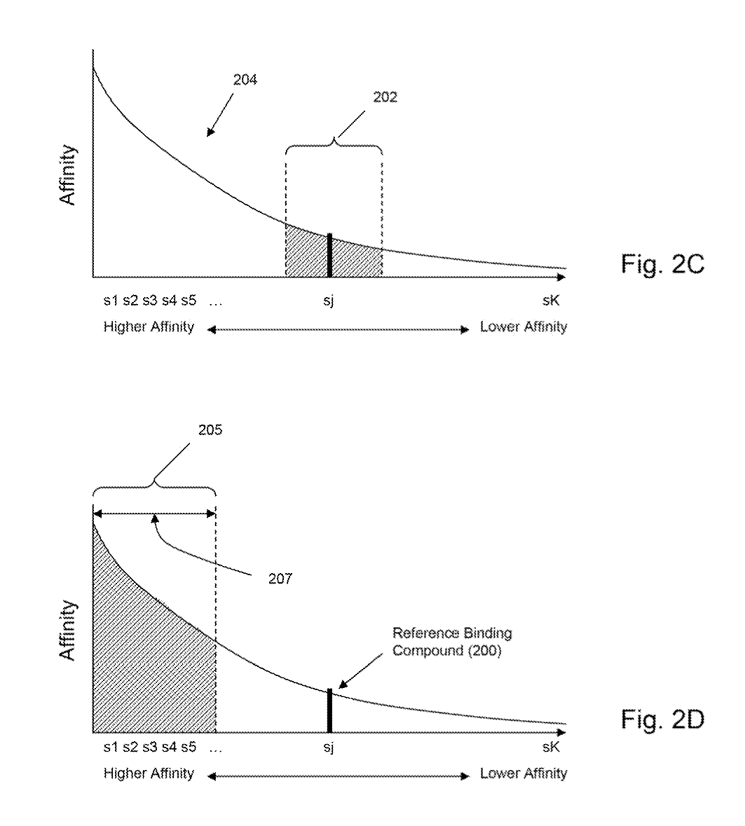

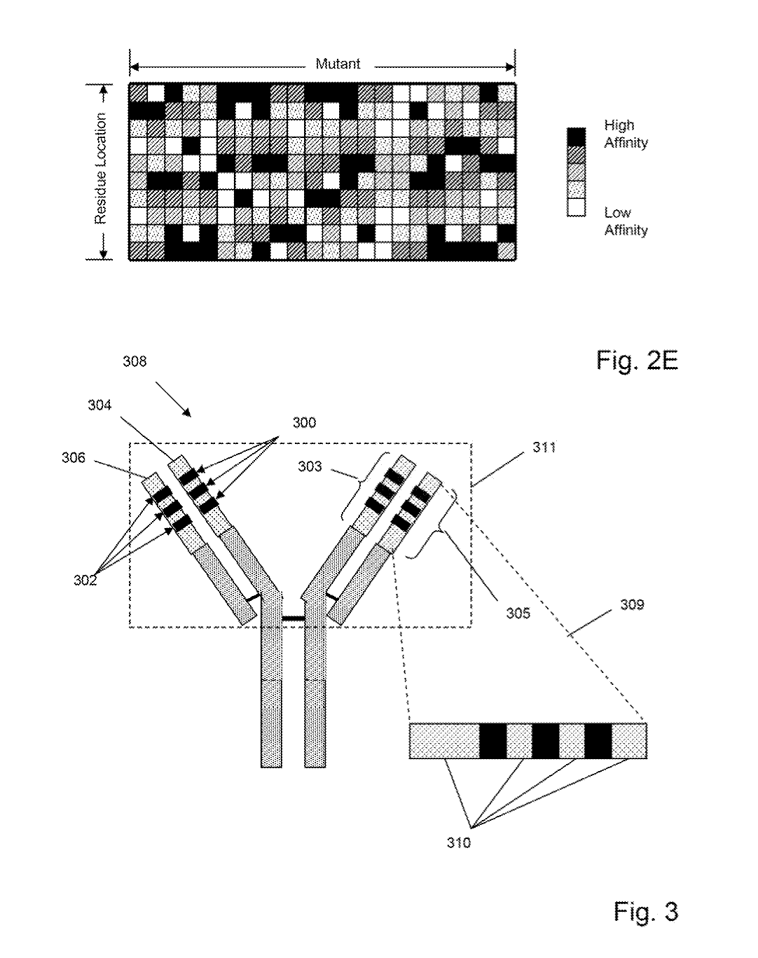

Nucleic acids encoding the binders and non-binders from the samples may be sequenced using any of variety of high-throughput DNA sequence analyzers (110), as described more fully below, to generate sequence data for binders (112) and non-binders (114). Conventional sample preparation procedures are employed that take into account the particular format of the candidate binding compounds. That is, binding compounds may be phage display, ribosome display, retroviral display, bacterial display, yeast display, or the like, and may require different steps to extract their nucleic acids and to prepare them for sequencing. The results of the sequence analysis are typically at least two tabulations or subsets of sequences corresponding to the binders (116) and non-binders (118). From such data of each subset, relationships between the frequency or abundance of sequences and the binding compounds they encode may be shown, as illustrated in FIGS. 2A-2B (where binding compounds have been ordered from highest frequency to lowest frequency), or between affinity and binding compound may be shown, as illustrated in FIGS. 2C-2D. (Likewise, similar relationships may be observed for nonbinders.) As mentioned above, sequences of the encoding nucleic acids of the binders (FIG. 2A) and non-binders (FIG. 2B) may be ordered in accordance with their frequencies in the two tabulations (i.e. tables (116) and (118) of FIG. 1B). FIG. 2A shows such an ordering (s₁, s₂, s₃, . . . sₖ) for binders, and FIG. 2B shows a corresponding ordering for non-binders. In accordance with the invention, sufficient numbers of sequences are obtained so that the frequencies of the sequences are reliable statistics of the actual populations in equilibrium under the given conditions.

Relative affinities of the nucleic acid-encoded binding compounds may be inferred from this data, as shown in FIGS. 2C-2D. In the case where a standard (or equivalently a reference or a wild type) binding compound (200) (having sequence sⱼ) is present, its position on the graph may be identified, as well as those of “bio-similars” (202) (i.e., in this case, sequences encoding binding compounds with equal or equivalent affinity to the antigen) and “bio-betters” (204) (i.e., in this case, sequences encoding binding compounds with superior affinity to the antigen). From relationships, as shown in FIG. 2C, binding compounds having different encoding sequences may be selected having the same or superior binding properties than that of a standard (or wild type or reference) binding compound. The relationships illustrated in FIGS. 2A-2C may also be represented equivalently in the form of a heat map (illustrated in FIG. 2E), where for example, an array of values (e.g. affinity) as a function of (usually) two parameters (e.g. amino acid or residue position and mutant residue) is represented by colors or shades of gray across a spectrum of colors or a gray scale.

For example, a heat map may consist of an array of affinity values for combinations of (i) amino acid positions in a variable region of a light chain of an antibody and (ii) type of amino acid. The affinity values may be represented by colors across a spectrum from violet (highest affinity) to red (lowest affinity) or by grays along a gray scale from black (highest affinity) to white (lowest affinity). Binding compounds encoded by nucleic acids of set (202) that have different amino acid sequences from the reference binding compound are of particular interest, particularly (but not solely) when amino acid differences occur in the CDRs. As used herein, such binding compounds are referred to as “neutral binding compounds” for (i) their equivalence in binding affinity to a selected pre-existing, or reference, binding compound, and (ii) their amino acid sequences that are different from the reference binding compound. This latter characteristic permits selection for improvements of other properties of interest, e.g. increased solubility, increased stability, reduced cross-reactivity, reduced immunogenicity, or the like.

In one embodiment, neutral binding compounds comprise a set of binding compounds whose affinities are within an order of magnitude, or in other words, a factor of ten, of the affinity of a reference binding compound; in another embodiment, a neutral binding compound comprise a set of binding compounds whose affinities are within forty percent of the affinity of a reference binding compound (i.e. either within forty percent higher than or within forty percent lower than the affinity of the reference binding compound). In another embodiment, neutral binding compounds comprise a set of binding compounds whose affinities are within ten percent of the affinity of a reference binding compound. In another embodiment, neutral binding compounds comprise a set of binding compounds whose affinities are within five percent of the affinity of a reference binding compound. In a further embodiment, neutral binding compounds comprise up to 100 candidate binding compounds having the closest affinity to that of a reference binding compound, but differing in amino acid sequence from the reference compound. In a further embodiment, neutral binding compounds comprise up to 1000 candidate binding compounds having the closest affinity to that of a reference binding compound, but differing in amino acid sequence from the reference compound.

In one aspect of the invention, the above method may be used to identify neutral binding compounds with respect to a reference compound using the following steps: (a) reacting under binding conditions a ligand with a library of candidate binding compounds and a reference binding compound, each candidate binding compound and the reference binding compound consisting of or being encoded by a nucleotide sequence; (b) determining the nucleotide sequences of binding compounds forming complexes with the ligand; (c) determining the nucleotide sequences of binding compounds free of ligand; (d) ordering the nucleotide sequences of the binding compounds in accordance with the affinities of their respective binding compounds for the ligand, wherein the affinities are determined by comparing the frequency of times a nucleotide sequence is identified among binding compounds forming complexes with the ligand and the frequency of times the same nucleotide sequence is identified among the binding compounds free of the ligand; and (e) identifying among the ordering of nucleotide sequences those nucleotide sequences whose orderings are adjacent to the ordering of a nucleotide sequence encoding the reference binding compound. In one embodiment, adjacent nucleic acids are nucleic acids encoding binding compounds whose affinities are within ten percent of the affinity of a reference binding compound (i.e. either within ten percent higher than or within ten percent lower than the affinity of the reference binding compound).

In some embodiments of the invention, the number of candidate binding compounds under consideration may be reduced in cases where improvements are sought to a pre-existing binding compound, i.e., a standard or reference binding compound, such as pre-existing known antibody, such as a known therapeutic antibody. For example, for a pre-existing antibody where the amino acid sequence of both its scaffold and binding regions are known, limited, or subregions of such sequences may be assessed for the effect of every possible single amino acid change in such subregions only and an estimate the combinatorial effects of multiple mutations may be obtained by adding the measured effects of the individual single amino acid changes. In other embodiments, such a process may be generalized by assessing the effect of every possible two-way amino acid change in the subregion, with an increased number of mutants requiring assessment. Such methods require a much smaller library to assess the effects of all the possible amino acid changes. For example, in the former embodiment, in a limited region of 50 amino acid positions, only 50×20=1000 mutants would need to be analyzed. In addition the assumption of achieving independent effects from multiple mutations used in combination is a good approximation when working with a small number of positions (<20).

Radioligand studies may be used to assess the above binding compound, but such studies usually are run serially, using multiple protein variants against a single radioligand in separate reactions, because the variant proteins are difficult to distinguish one from another. One could run multiple binding studies simultaneously, in the same reaction vessel, if the variant receptors were readily distinguishable from one another. This situation can be achieved using any of a number of viral, phage, or ribosome display formats, as described below. In these systems the variant receptors are displayed in low numbers (≦10 copies/particle) on the surface of viral, phage or ribosome particles. In these situations the specific nucleic acid that encoded the variant receptor is contained within the cognate virus/phage/ribosomal particle (also referred to herein as a nucleic acid-encoded binding compound). This allows easy identification of each specific protein variant by sequencing the nucleic acid that is attached to it. If this principle is applied to binding experiment described above, one can easily measure the binding affinities of large numbers of protein variants simultaneously by running an equilibrium binding assay using a vines/phage/ribosomal library (collection of variants) against a single ligand (either bound to a substrate or in solution). After equilibrium has been reached the bound receptors (phage/virus/ribosomal particles) can be collected by recovering the ligand molecules via immunoprecipitation or substrate recovery and the unbound receptors can be recovered from the supernatant. These two samples of phage/virus/ribosome particles can then be sequenced on a massively parallel fragment sequencer (as described below) to determine each clone's contribution to the bound and free pools of receptors.

From this sequence information the bound percentage of each receptor in the library can be calculated. Those receptors with the highest percentage of bound phage/virus/ribosomes will have the highest affinities and those with the lowest bound percentages will have the lowest affinities. Using a single ligand concentration near the dissociation constant, K_{D}, of the parent protein, it is possible to rank the affinities every protein variant for a given ligand. If the parent molecule is encoded in the library, then the affinities of all of the variants in the library can be assessed relative to the parent protein, which serves as an internal standard or reference. If the ligand is in great excess in the binding reaction (so its unbound concentration docs not change appreciably during the binding reaction) and several binding reactions are run using varying ligand concentrations, then one is able to use non-linear regressions or equivalent calculation to rapidly calculate the K_{D} for every variant in the population from the equation K_{D}=[A][B]/[AB], where [A] is the concentration of a first member of a binding pair in the unbound state, [B] is the concentration of a second member of a binding pair in the unbound state, and [AB] is the concentration of the first and second members in the bound state. In some embodiments employing protein display systems, such as phage display libraries, some properties of interest, such as affinities, may be estimated as follows based on tabulated sequences of nucleic acids encoding binding compounds. For example, for measuring relative affinities, multiple reactions are set up, e.g. in wells of a microtiter plate, or the like, such that the reactions contain a dilution series of ligand, i.e. a series of lower and lower concentrations or amounts of ligand adsorbed or attached to a solid support, such as the surface of a microwell wall, magnetic bead, or the like. To each reaction is added a fixed number of display organism, such as aliquots of a phage display library, and the reactions are allowed to go to equilibrium. After equilibrium has been reached, bound and free display organisms are harvested and binding-compound encoding nucleic acids are amplified in separate polymerase chain reactions (PCRs) to determine the reaction in which the concentration, or amount, of ligand results in about equal amounts of display organism bound to ligand and free. Under such conditions, affinities of the binding compounds may be estimated as ratios of bound binding compound (determined by counting encoding nucleic acids) and unbound binding compound (also determined by counting encoding nucleic acids).

In some embodiments, a similar operation may be used to estimate affinities of binding compounds of a library relative to that of a reference binding compound (as used herein, such values are referred to as “relative affinities” with respect to a selected reference compound). As above, multiple reactions are set up with a dilution series of immobilized ligand. To each reaction is added a fixed amount of reference binding compound (e.g. a single phage displaying the reference binding compound) and the reactions are allowed to go to equilibrium. After equilibrium has been reached, bound and free display organisms are harvested and their encoding nucleic acids are amplified in separate PCRs to determine the reaction in which the concentration, or amount, of ligand results in about equal amounts of reference binding compound bound to ligand and free of ligand. The determined reaction provides conditions for carrying out library-based binding reactions so that ratios of binders to nonbinders for each library member can be computed and compared to that of a reference binding compound to give a measure of the relative affinity of such member to a ligand.

In one aspect, statistically significant information is obtained about how structural elements of proteins, e.g. position and identity of amino acid residues in binding domains, relate to functional properties of interest, such as binding affinity, specificity, expression, stability, cross-reactivity, and the like. As mentioned above, such information is collected by identifying sufficient numbers of binding compounds that are segregated or separated into subsets in selection reactions. For example, for relative affinities, such information may be collected by reacting under binding conditions a set of candidate nucleic acid-encoded binding compounds with one or more target molecules, so that complexes form between the one or more target molecules and at least a portion of the candidate binding compounds (referred to herein as “binders”). Sufficient numbers of candidate binders and non-binders are then decoded by high throughput nucleic acid sequencing to give statistically significant data about the binding properties of substantially all the members of the set of candidate binding compounds. In other words, sample sizes are large enough so that the numbers of candidate binders and non-binders decoded and recorded are subject to minimal sampling error. As mentioned above, in some embodiments, statistically significant values of properties of interest (such as, relative affinity, expression level, stability, and the like) are obtained when such values are measured with coefficients of variation (CVs) less than or equal to ten percent; or in other embodiments, with CVs less than or equal to five percent; or in other embodiments, with CVs less than or equal to two percent. Whenever degenerate codons are used when synthesizing candidate binding compounds, CVs of properties of interest, such as relative affinity, or the like, are readily determined from the numbers of sequences counted which contain different codons that encode the same amino acid. For example, if candidate binding compounds of a library are generated from nucleotide sequences each containing a degenerate codon, “NNN”, at each of a number of different sites, then at each such site there will be, for example, six codons encoding serine, four codons encoding valine, and so on. If the expression of the candidate binding compounds is assumed to be uniform, then the degree of deviation from equal representation of each alternative serine codon, or valine codon, or the like, among the enumerated sequences in a selection assay is related to, and a direct measure of, the CV of the encoded binding compound. That is, such deviation is a measure of sampling error, which may be reduced by increasing the number of nucleotide sequences analyzed for a given library and selection assay. In one aspect of the invention, CVs of values of properties of interest (e.g. relative affinities, expression levels, stabilities, cross-reactivities, and the like) are conveniently estimated from the CVs of counts of nucleotide sequences with synonymous codons that encode the same binding compound. In one embodiment, such CVs are estimated based on amino acids having from four to six synonymous codons.

The statistically significant information is contained in the tabulations of the sequences of nucleic acids encoding the binders and the non-binders in the different selection reactions. Nucleic acid-encoded binding compounds may be obtained from the various antibody display techniques, aptamers, or the like, such as those described below. In some embodiments, the structural elements that are analyzed are spatially local in the sense that they exert their effects on binding within or near a limited volume of a larger molecule, such as, an enzyme active site, antibody binding site, complementary-determining regions, or the like. In particular, structural elements analyzed in an antibody binding interaction includes CDRs as well as framework regions of antibody variable regions. Alternatively, such information may be collected by first decoding the sequences of members of the total effective library of candidate nucleic acid-encoded binding compounds, (or an adequate sample thereof to ensure nearly complete coverage (e.g. at least 95%, or at least 98%, or at least 99% coverage)), prior to carrying out a binding reaction with the one or more target molecules, or ligands. As used herein, “total effective library” means the total library of nucleic acid-encoded binding compounds, subject to any biases in sequence representation that may arise in the course of expression, e.g. in phage, ribosomes, bacteria, yeast, or the like. A binding reaction is carried out as described above, after which the nucleic acid sequences of only the binders are determined. From this information, a ratio may be formed for each candidate nucleic acid-encoded binding compound that consists of the number of sequence reads among the binders over the number of sequence reads in the total library as a measure of its binding strength or affinity. That is, the larger the value of the ratio of a candidate binding compound, the stronger its affinity for the one or more target molecules and the lower the value of the ratio the lower its affinity. Generally, such ratios and other ratios, such as ratios of binders to nonbinders, provide relative affinities of each of the binding compounds in the reaction with the one or more ligands.

### Relative Expression Levels

In one aspect, the method of the invention allows the identification of mutants (for example, from a library of variants of a reference binding compound) that have both equivalent binding affinity with respect to a reference binding compound for a particular ligand and higher expression in a selected host organism than that of the reference compound. (Other embodiments may also provide variants with both higher affinity and higher expression than that of a reference binding compound). As described more fully below, a large variety of expression systems may be used with this aspect of the invention. Preferably, such expression systems permit (a) surface expression of library variants (i.e. candidate binding compounds) and (b) expression of an internal standard which is expressed at the same level for all library variants and which thereby permits relative expression of the variant to be measured. In one embodiment, the internal standard is another protein expressed on the surface of the expression host; thus, a ratio of signals from probes directed to the two sets of surface molecules may be used as a measure of the expression level of the variant.

In some forms of this embodiment, the surface protein used as an internal standard is engineered to have the same transmembrane domain as the candidate binding compound (or conversely, in some embodiments, candidate binding compounds are engineered to have the same transmembrane domain as the internal standard). In another embodiment, both the expression of the library variant and the internal standard are measured by labeled antibodies, e.g. one labeled antibody specific for library variants and the other labeled antibody specific for the internal standard. In some embodiments, expression vectors include TRES elements for simultaneous expression of the library variant and internal standard, as illustrated below. In one embodiment the labeled antibodies have distinct fluorescent labels, so that relative expression is conveniently measured by a flow system, or like technology. When library variants are antibodies, variant-specific antibodies may bind to the constant regions of the variants, which will be identical for all library variants. In some embodiments, a variant library is constructed and maintained in a phage display vector that allows the affinity properties of variant to be readily analyzed as described above and that permits coding regions to be conveniently excised and inserted into other expression systems, such as mammalian, yeast and bacterial expression systems described in this section.

Many examples of amino acid changes that decrease a given protein's expression level exist in nature, but finding sequence changes that increase a protein's expression level has been difficult (PloSOne, May 23, 2007, c467). An optimal amino acid sequence for a given gene's expression in E. coli may not be the same as that gene's optimal amino acid sequence for expression in mammalian cells, or other host organisms. Therefore expression optimization may need to be done in a host specific manner, using a bacterial display system to optimize expression in bacteria, using a yeast display system for optimizing expression in yeast, using a mammalian display system to optimize expression in mammalian cells. In one embodiment, the following strategy may be used in any cellular system given an appropriate expression vector for that species. To control for vector copy number or integration site biases in the expression of members of a library, a second gene is included on the vector whose expression is used as a standard.

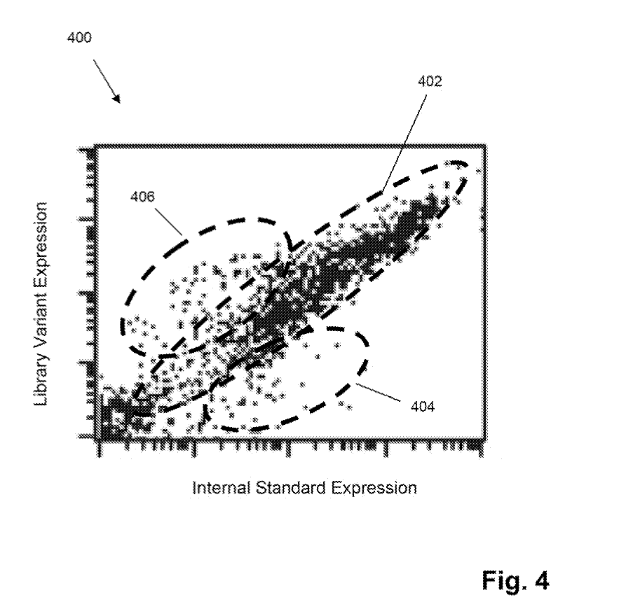

In one example for use in mammalian cells, either a transient vector (such as, SV40) or a stable replicon (such as, EBV) may be used with members of a candidate library inserted as one expression unit and the hCD4 gene (for example) as a second “internal standard” expression unit (expressed either from its own promoter or via a linked internal ribosome entry site (IRES), e.g. U.S. Pat. No. 6,653,132, or the like). If the gene of interest is tethered to the cell surface via a linked transmembrane domain (preferably derived from the hCD4 gene), then the expression of both genes from each vector can be quantified on the cell surface. Also since both proteins share the same transmembrane domain, the number of copies of each protein on the cell surface should be a function of its expression level. If we used different colored staining reagents to detect each of the two proteins and stained a population of cells transfected with the expression vector and quantified the expression of both proteins with a fluorescence-activated cell sorter (FACS), or like instrument, most cells would fall along the diagonal, e.g. region (402) on a 2D plot (400), as illustrated in FIG. 4. The more a given cell expressed the library gene (Ab), the more it will tend to express the internal standard gene (e.g. CD4). Some cells (carrying genes with mutations that inhibit expression) will produce less antibody for every level of CD4, these clones would drop below the diagonal on a FACS plot, e.g. region (404). The other group, i.e. cells expressing relatively more antibody, will be detectable above the diagonal, e.g. region (406) on a FACS plot (400). As with relative affinities, expression levels of particular variants may be obtained with high statistical reliability by collecting a sufficient number of measurements (for example) by flow systems analysis of the expression hosts. Such data collection is well known in the field of flow cytometry. In one embodiment, values of expression levels have CVs less than or equal to ten percent; in another embodiment, values of expression levels have CVs less than or equal to five percent; in another embodiment, values of expression levels have CVs less than or equal to two percent. The latter clones will express more antibody for every level of CD4 produced. These higher-expressing cells may then be isolated using the FACS sorter function and sequenced to identify the library variant that result in higher expression. Multiple mutations that allowed for higher expression could be combined to potentially give an even larger boost to the expression level of the protein of interest.

A. Mammalian Cell Expression

A wide range of mammalian expressions systems are available for use with the inventions, including those providing stable integration of expression vectors into a host genome as well as transient and stable episomal maintenance of expression vectors. Exemplary expression systems with internal standard and surface display expression are disclosed in the following references, which are incorporated by reference: Liu et al, Anal. Biochem, 280: 20-28 (2000); Mancia et al, Structure, 12: 1355-1360 (2004); Sleiman et al, Biotechnology & Bioengineering, 99: 578-587 (2008); Akamatsu et al, J. Immunol. Methods, 327: 40-52 (2007); Zhou et al, mAbs, 2(5): 508-518 (2010); Aruffo et al, Proc. Natl. Acad. Sci., 84: 8573-8577 (1987); U.S. patent publication 2010/0009866; and the like. Reagents for implementing such expression systems are also available commercially, e.g. Miltenyi Biotec (Auburn, Calif.); Life Technologies (Carlsbad, Calif.); Sigma-Aldrich (St. Louis, Mo.); and the like. In one aspect, a mammalian expression system used with the invention comprises a stable episomal expression vector in a mammalian cell host.

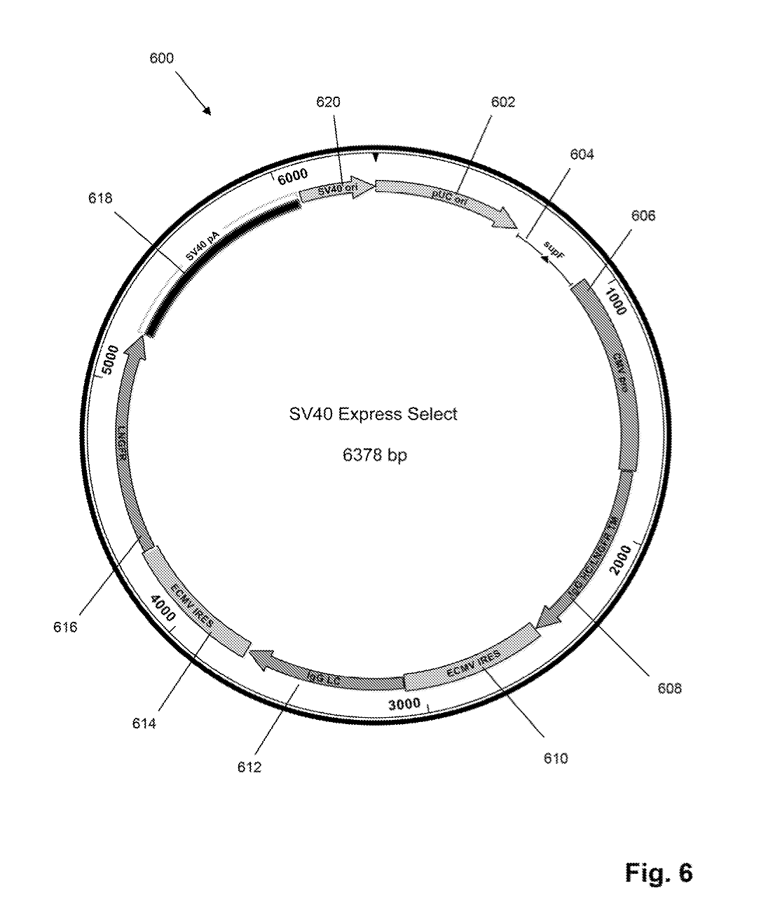

Exemplary transient expression vectors include SV40-based expression vectors such as illustrated in FIG. 6. Such vectors may be expressed in mammalian cells such as COS cells, 293T cells, and the like, after transfection by conventional techniques, e.g. electroporation. Elements of vector SV40 Express Select (600) are commercially available and may be assembled using conventional techniques. Vector (600) contains the following elements: pUC origin of replication (602); selectable marker, supF (604); CMV promoter (606); immunoglobulin heavy chain coding region fused to LNGFR transmembrane domain (608); first ECMV IRES element (610); immunoglobulin light chain coding region (612); second ECMV IRES element (614); internal standard or other screenable gene (616), LNGFR in this example; SV40 polyadenylation site (618); and SV40 origin of replication (620).

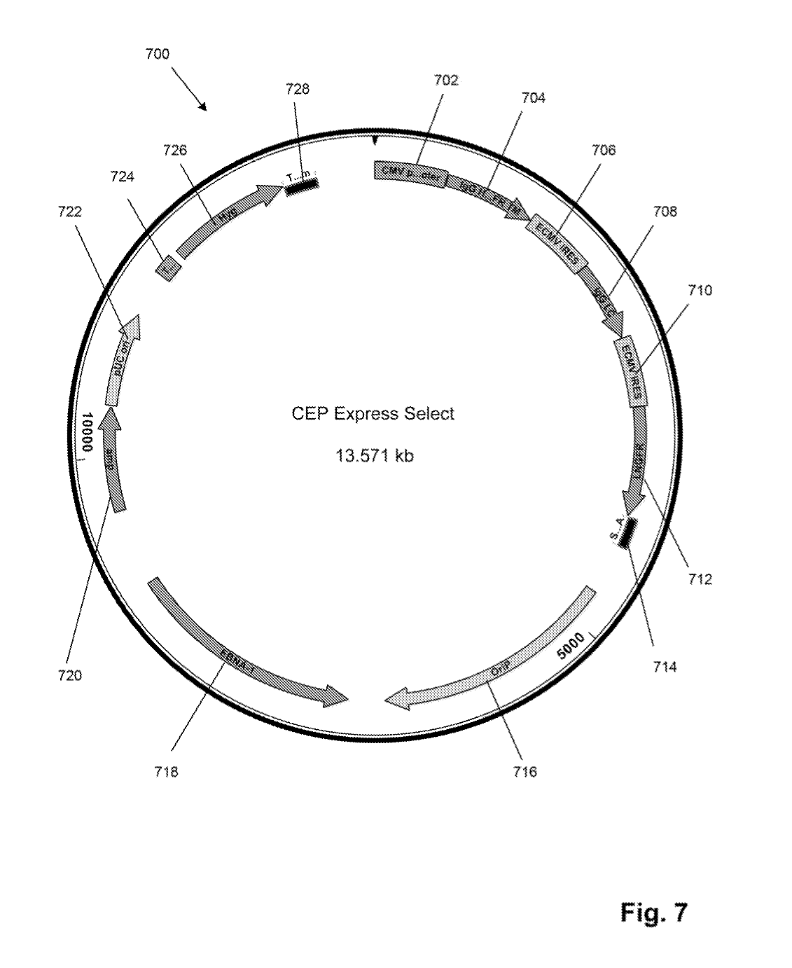

Exemplary stable episomal expression vectors include EBV-based mammalian expression vectors such as illustrated in FIG. 7. CEP Express Select vector (700) contains the following elements: CMV promoter (702); immunoglobulin heavy chain coding region fused with the transmembrane domain of LNGRF (704); first ECMV IRES (706); immunoglobulin light chain coding region (708); second ECMV IRES (710); internal standard (LNGFR)(712); SV40 polyadenylation site (714); EBV origin of replication (716); nuclear antigen 1 (EBNA-1) gene (718); ampcilin resistance gene (720); pUC origin of replication (722); thymidine kinase (TK) promoter (724); hygromycin resistance gene (726); and TK terminator (728).

B. Yeast Expression

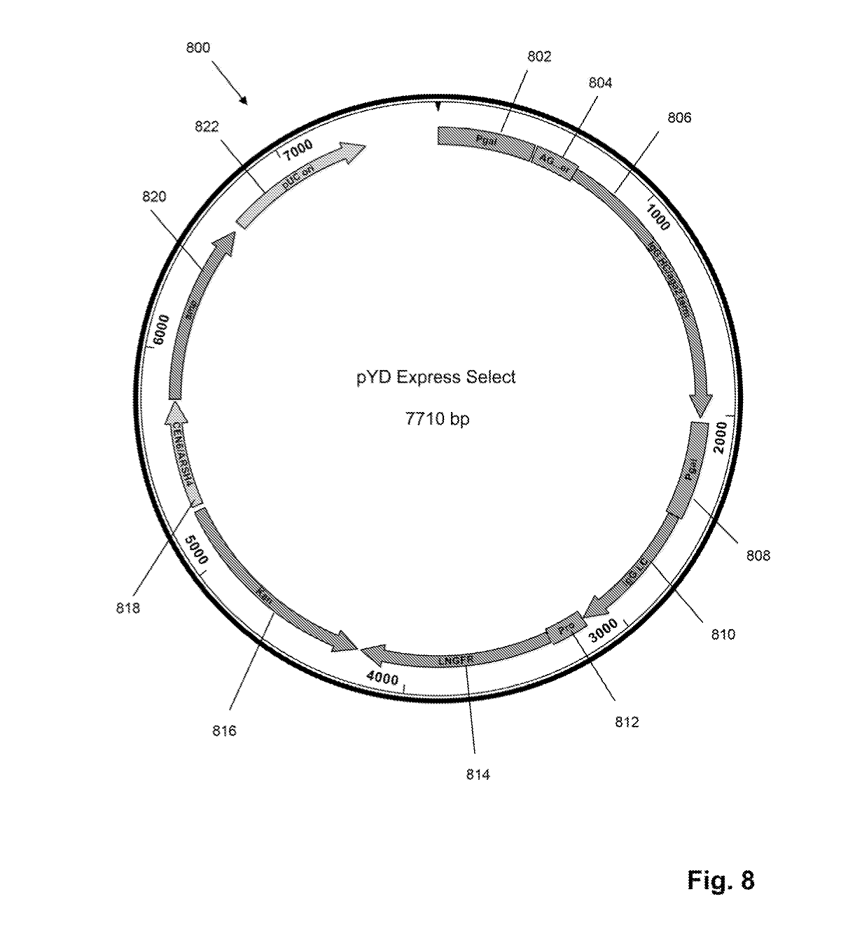

Relative expression of library variants may also be assessed in a yeast expression system, such as pYD1 described in “pYD1 Yeast Display Vector Kit” (Invitrogen, 2002); pDisplay (Invitrogen, 2010); or the like. Library variants are inserted into such vectors using manufacturer's recommended protocols. Other yeast display systems for use with this aspect of the invention are also disclosed in Boder et al, Proc. Natl. Acad. Sci., 97(20): 10701-10705 (2000); Weaver-Feldhaus et al, FEBS Letters, 564: 24-34 (2004); and like references. An exemplary genetic map of a pYD1 for use with the invention is illustrated FIG. 8. In this embodiment, pYD Express Select vector (800) contains the following elements: first GAL1 promoter (802); AGA2 leader sequence (804); immunoglobulin heavy chain coding region fused to AGA2 cell wall attachment site (806); second GAL1 promoter (808); immunoglobulin light chain coding region (810); Pro element (812); internal standard (LNGFR) with AGA2 cell wall attachment site (814); kanomycin resistance gene (816); CEN6/ARS4 element (818) for stable episomal replication in yeast; amplicilin resistance gene (820); pUC origin of replication (822).

C. Bacterial Expression

Relative expression of library variants may also be assessed in bacterial surface display systems, such as disclosed in Francisco et al, Proc. Natl. Acad. Sci., 90: 10444-10448 (1993).

D. Antibody Formats

Even though the above exemplary expression systems are designed for antibody binding compounds in the IgG format, it would be clear to one of ordinary skill that similar expression systems may be engineered for other antibody binding compound formats, including but not limited to, antibody fragments, or other antibody isotypes, bispecific antibodies, or the like.

### Binding Compound Stability

In some embodiments, the method of the invention may be used to obtain a binding compound with equivalent or better affinity as that of a reference binding compound, but which has superior stability with respect to selected destabilizing agents. A subset of candidate compounds identified as described above based on affinity is separated into at least two portions. Members of a first portion are compared to members of a second portion after members of the latter portion have been treated with a destabilizing agent (heat, low pH, proteases, or the like). That is, both portions originated from the same starting subset of candidate binding compounds, except that the members of the second portion are subjected to a destabilizing agent. In other words, its members form a “stressed” library. The candidate binding compounds from such a library that lose binding affinity after being “stressed” contain destabilizing residues. A goal is to identify mutants that bind the antigen at least as well or better than wild type in the “stressed” library. It is expected that several stabilizing mutations could be combined to dramatically increase the stability of the molecule, for example, by forming a second-stage library from such mutants and conducting a second round of selection. In some embodiments, the above may be implemented in accordance with the invention to increase stability of a selected nucleic acid-encoded binding compound (i.e. reference binding compound) without loss of affinity for a ligand by the steps of: (a) treating a library of candidate binding compounds with a destabilizing agent to form a treated library of candidate binding compounds, each candidate binding compound being comprised of or encoded by a nucleotide sequence; (b) reacting under binding conditions one or more ligands with the treated library of candidate binding compounds; (c) determining the nucleotide sequences of the candidate binding compounds forming complexes with the one or more ligands; (d) determining for each candidate binding compound an affinity based on a ratio of a number of nucleotide sequences of binding compounds forming a complex to its total number in the treated library; and (c) selecting at least one candidate binding compound from a subset of candidate binding compounds whose affinity is equal to or greater than that of the selected nucleic acid-encoded binding compound (that is, the reference binding compound), thereby providing a nucleic acid-encoded binding compound with increased stability with respect to the reference binding compound without loss of affinity.

As with relative affinities, stability of particular variants may be obtained with high statistical reliability by collecting a sufficient number of measurements in stability selection assays, such as described herein. In one embodiment, values of stability have CVs less than or equal to ten percent; in another embodiment, values of stability have CVs less than or equal to five percent; in another embodiment, values of stability have CVs less than or equal to two percent. As used herein, “values of stability” are the relative affinity values determined from members of a treated library.

In some embodiments, for example, for binding compounds expressed in phage display systems, exemplary conditions for stressing a subset include (i) exposing phage to elevated temperatures, e.g. in the range of 50-70° C. for a period of time, e.g. in the range of 15-30 minutes; (ii) exposing phage to low pH, e.g. pH in the range of 1-4, for a period of time, e.g. in the range of 15-30 minutes; (iii) exposing phage to various proteases at various activities over a range for a period of time, e.g. 15-30 minutes, or 1-4 hours, or 1 hour to 24 hours, depending on the protease and specific activity. Exemplary proteases for stability testing include, but are not limited to, serum proteases; trypsin; chymotrypsin; cathepsins, including but not limited to cathepsin A and cathepsin B; endopeptidases, such as, matrix metalloproteinases (MMPs) including, but not limited to, MMP-1, MMP-2, MMP-9; or the like.

### Binding Compound Cross-Reactivity

In some embodiments, the method of the invention may be used to obtain a binding compound with equivalent or better affinity to a target antigen as that of a reference binding compound, but that has reduced cross reactivity, or in some embodiments, increased cross reactivity, with selected substances, such as ligands, proteins, antigens, or the like, other than the substance or epitope for which a reference binding compound is specific, or is design to be specific for. In regard to the latter, a candidate therapeutic antibody may be more successfully tested in animal models if the antibody reacted with both its human target and the corresponding target of the animal model, e.g. mouse. Thus, in some embodiments, the method of the invention may be employed to increase cross reactivity with selected substances, such as corresponding animal model targets. In other embodiments, the method of the invention is employed to reduce cross reactivity of a candidate therapeutic antibody, for example, to reduce potential side effects in a patient. As above, a subset of candidate compounds is identified based on affinity (i.e. having equivalent or higher affinity than that of the reference compound). Candidate compounds from the subset may then be combined with one or more substances other than the target antigen in one or more binding reactions (e.g. each at different phage concentrations) to determine the affinities of such candidate binding compounds to such substances. The choice of substances may vary widely, and may include tissues, cell lines, selected proteins, tissue arrays, protein microarrays, or other multiplex displays of potentially cross reactive compounds. Guidance for selecting such antibody cross reaction assays may be found in the following exemplary references: Michaud et al, Nature Biotechnology, 21(12): 1509-1512 (2003); Kijanka et al, J. Immunol. Methods, 340(2): 132-137 (2009); Predki et al, Human Antibodies, 14(1-2): 7-15 (2005); Invitrogen Application Note on Protoarray™ Protein Microarray (2005); and the like. In such binding reactions, nucleic acids encoding binders and non-binders from the subset are determined in accordance with the invention, thereby providing statistically significant values of dissociation constants of each candidate binding compound of the subset for the one or more selected substances for which cross reactivity information was sought. CVs of relative affinities for cross-reaction to test compounds may be determined as described above. Knowledge of the sequences of low-cross reactivity mutants may be used to generate a second stage library to identify binding compounds with further reduced cross reactivity with the selected substances.

In some embodiments, the above may be implemented in accordance with the invention to identify one or more binding compounds with reduced cross reactivity with a selected set of substances compared to that of a reference binding compound without loss of affinity for a ligand. Such method may be carried out by the steps of: (a) reacting under binding conditions one or more ligands with a library of binding compounds comprising a reference binding compound and mutants thereof, the reference binding compound and each mutant thereof being encoded by a nucleotide sequence; (b) determining the nucleotide sequences of binding compounds forming complexes with the one or more ligands to obtain a relative affinity for each thereof based on a number of nucleotide sequences enumerated for each such binding compound, respectively, each relative affinity having a coefficient of variation of ten percent or less; (c) reacting under binding conditions the one or more selected substances with the library and determining the nucleotide sequences of binding compounds forming complexes with the one or more selected substances to obtain a relative affinity for each thereof based on a number of nucleotide sequences enumerated for each such binding compound, respectively, each relative affinity having a coefficient of variation of ten percent or less; and (d) selecting mutants of the reference binding compound that have a relative affinity equal to or greater than that of the reference binding compound for the one or more ligands and a relative affinity equal to or less than that of the reference binding compound for the one or more selected substances.

### Protein Display Systems

Features of any peptide or protein display system are: 1. Tight linkage between the expressed proteins and their encoding nucleic acid; and 2. Expression of the protein in a format that allows it to be assayed and separated based on some biochemical activity (for example, binding strength, susceptibility to enzymatic action, or the like). For the purposes of this discussion, protein display systems can be separated into two groups based on the number of displayed proteins per display unit, either polyvalent or monovalent. The polyvalent display systems such as yeast display (references 1 and 2 below), mammalian display systems (references 3 and 4 below) and bacterial display systems (reference 5) express the gene(s) of interest (often diverse antibody libraries) as proteins tethered to the cell surface by means of a membrane anchor, similar to a native surface immunoglobulin found on the plasma membrane of normal B-cells. DNA encoding the library clones is transformed into the cell type of interest such that each cell receives at most one clone from the library. The resultant population of cells will each express tens to tens of thousands of copies of a single protein clone on their cell surfaces. This population of cells can then be exposed to limiting amounts of fluorescently labeled target antigen and the best binding clones will bind the most antigen and they can be identified and isolated using a fluorescence-activated cell sorter (FACS). Unfortunately accurate quantitation in polyvalent display systems is complicated by cooperative binding effects (avidity) between the multiple copies of the displayed molecule on the same cell (reference 6). This problem is especially pronounced if the antigen is polyvalent (TNF, IgG) or bound to a cell surface (e.g. CD 20).

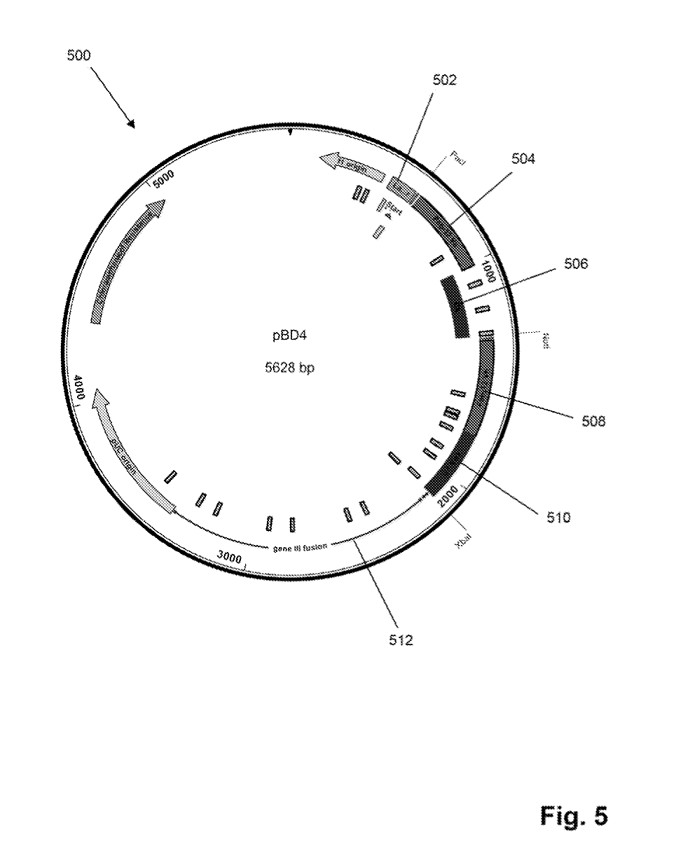

Many of the viral and phage-based protein display systems are also polyvalent in nature, but the display units are too small to detect on the FACS, so accurate quantitation is even more difficult. These systems also suffer from avidity problems if multiple binding compounds are expressed simultaneously on the same phage particle. Under such conditions it is difficult to determine whether an observed binding strength is due to the combined effect of two expressed binding compounds versus the effect of a single very high affinity binding compound. Such avidity problems may be minimized by regulating the expression of candidate binding compound in a host using conventional techniques. In one embodiment in which a phage display system expresses Fab fragments, e.g. as disclosed in FIG. 5, regulation of Fab expression is adjusted so that the fraction of phage expression Fab is in the range of from about 0.002 to 0.001, or in the range of about 0.001 to 0.0005.

The monovalent phage (reference 7) and viral (reference 8) systems, along with the ribosome display systems (references 9 and 10) express an average of ≦1 molecule of the displayed molecule per display unit. These systems yield accurate measurements of the true affinity of the binding site in question for each clone in the library. Generally these systems are used to display large, diverse libraries of binding elements. Small subpopulations of clones are then selected from these libraries based on their increased ability to bind the target antigen relative to other members of the library. After selection (often multiple rounds of selection) the resultant clones are isolated and characterized (e.g. as disclosed in U.S. Pat. No. 7,662,557 which is incorporated herein by reference). This is a good strategy for isolating initial binders to a given target antigen from a very large and diverse library, but is not an efficient method for mapping a single protein binding site for the purposes of protein engineering. To achieve this goal one would like to characterize the effect of every possible engineering change and then design and construct an optimized binding site based on: affinity, stability, cross-reactivity, immunogenicity, circulating half-life, manufacturing yield, etc. Therefore it would be desirable to analyze the binding strength of every member of a saturated, single substitution library of the binding site in question. The above protein display techniques are disclosed in the following exemplary references, which are incorporated herein by reference: (1) Wittrup, K D; Current Opinion in Biotechnology 12: 395-399 (2001) (Protein engineering by cell-surface display); (2) Lauren R. Pepper, Yong Ku Cho, Eric T. Boder and Eric V. Shusta; Combinatorial Chemistry & High Throughput Screening 11: 127-134 (2008); (3) Yoshiko Akamatsu, Kanokwan Pakabunto, Zhenghai Xu, Yin Zhang, Naoya Tsurushita; Journal of Immunological Methods 327: 40-52 (2007); (4) Chen Zhou, Frederick W. Jacobsen, Ling Cai, Qing Chen and Weyen David Shen; mAbs 2(5): 1-11 (2010); (5) Patrick S Daugherty; Current Opinion in Structural Biology 17:474-480 (2007) (Protein engineering with bacterial display); (6) Clackson and Lowman (editors), Phage Display (2009); (7) Hennie R Hoogenboom, Andrew D Griffiths, Kevin S Johnson, David J Chiswell, Peter Hudson and Greg Winter; Nucleic Acids Research 19(15): 4133-4137 (1991); (8) Francesca Gennari, Luciene Lopes, Els Verhoeyen, Wayne Marasco, Mary K. Collins; Human Gene Therapy 20: 554-562 (2009); (9) Christiane Schaffitzel, Jozef Hanes, Lutz Jermutus, Andreas Pluckthun; Journal of Immunological Methods 231: 119-135 (1999) (ribosome display); (10) Robert A Irving, Gregory Coia, Anthony Roberts, Stewart D Nuttall, Peter J Hudson; Journal of Immunological Methods 248: 31-45 (2001) (ribosome display); (11) Arvind Rajpal, Nurten Beyaz, Laurie Haber, Guido Cappuccilli, Helena Yee, Ramesh R Bhatt, Toshihiko Takeuchi, Richard A Lerner, Roberto Crea; PNAS 102 (24): 8466-71 (2005). Some of the above techniques are also disclosed in the following patents, which are incorporated herein by reference: 7,662,557; 7,635,666; 7,195,866; 7,063,943; 6,916,605; and the like.

Further protein display systems for use with the invention include baculoviral display systems, adenoviral display systems, lentivirus display systems, retroviral display systems, SplitCore display systems, as disclosed in the following references: Sakihama et al, PLosOne 3(12): e4024 (2008); Makela et al, Combinatorial Chemistry & High Throughput Screening, 11: 86-98 (2008); Urano et al, Biochem. Biophys. Res Comm., 308: 191-196 (2003); Gennari et al, Human Gene Therapy, 20: 554-562 (2009); Taube et al, PLosOne, 3(9): e3181 (2008); Lim et al, Combinatorial Chemistry & High Throughput Screening, 11: 111-117 (2008); Urban et al, Chemical Biology, 6(1): 61-74 (2011); Buchholz et al, Combinatorial Chemistry & High Throughput Screening, 1: 99-110 (2008); Walker et al, Scientific Reports, 1(5): (14 Jun. 2011); and the like.

In some embodiments, the invention employs conventional phage display systems for improving one or more properties of a antibody binding compound, particularly a preexisting antibody binding compound. Unlike prior applications of display technologies, which employ repeated cycles of selection, washing, elution and amplification, to identify individual phage from a large library, e.g. >10⁸-10⁹ clones, in the present invention, a single equilibrium binding reaction is created using a relatively small and focused library, e.g. 10³-10⁴ clones, or in some embodiments 10⁴-10⁵ clones, after which binder and non-binders are analyzed by large-scale sequencing. From such analysis, subsets are selected and, optionally, further selected based on other properties of interest, such as, solubility, stability, lack of immunogenicity, and the like. Factors affecting such equilibrium reactions are well-known in the art and include: the number of phage to include in the reaction, the stringency of the reaction mixture; the number of target molecules to include in the reaction; presence or absence of blocking agents, such as, bovine scrum albumin, gelatin, casein, or the like, to reduce nonspecific binding; the length and stringency of a wash step to separate non-binders; the nature of an elution step to remove binders from the target molecules; the format of target molecules used in the reaction, which, for example, may be bound to a solid support or derivatized with a capture agent, e.g. biotin, and free in solution; the phage protein into which candidate binding compounds are inserted; and the like. In one aspect, target molecules, such as proteins, are purified and directly immobilized on a solid support such as a bead or microtiter plate. This enables the physical separation of bound and unbound phage simply by washing the support. Numerous supports are available for this purpose, including modified affinity resins, glass beads, modified magnetic beads, plastic supports, and the like. Useful supports are those that have low background for nonspecific phage binding and that present the target molecules in a native configuration and at a desirable concentration.

In some embodiments, a nucleic acid-encoded binding compound is an antibody fragment expressed by a phage. In one embodiment, such phage is a filamentous bacteriophage and the antibody fragment is expressed as part of a coat protein. In particular, such phage may be a member of the Ff class of bacteriophages. In a further embodiment, the host of such filamentous bacteriophage is E. coli. In another embodiment, a phagemid-helper phage system is used for displaying antibody fragments. Phagemids may be maintained as plasmids in a host bacteria and phage production induced by further infection with a helper phage. Exemplary phagemids include pComb3 and its related family members, e.g. disclosed in Barbas et al, Proc. Natl. Acad. Sci., 88: 7978-7982 (1991), and pHEN1 and its related family members, e.g. disclosed in Hoogenboom et al, Nucleic Acids Research, 19: 4133-4137 (1991); and U.S. Pat. Nos. 5,969,108; 6,806,079; 7,662,557; and related patents, which are incorporated herein by reference. In a particular embodiment, an antibody fragment is expressed as a fusion protein with phage coat protein g3p.

### Libraries of Nucleic Acid-Encoded Binding Compounds

As mentioned above, a feature of the invention is the use of focused libraries from which reliable values for properties of interest, such as relative affinities, expression levels, stabilities, and the like, can be obtained. In one aspect, this eliminates the need for successive cycles of selection, elution, and amplification, as required in conventional approaches. The size of such focused libraries of candidate binding compounds is influenced by at least two factors: the scale of sequencing required for analyzing selected and non-selected binding compounds, such as, binders and nonbinders, and the difficulty of synthesizing polynucleotidcs that encode library members. That is, the larger the library of candidate compounds and the higher the degree of confidence desired in the binding statistics of each compound both require that more binders and nonbinders be sequenced. Likewise, a larger library of candidate compounds means a greater number of polynucleotides need to be synthesized.

A experimental quantity that embodies the above trade-off is the coefficient of variation (CV) of the measured value of a property of interest, such as relative affinity of a particular binding compound. In one aspect, library size and sequencing scale are selected so that the values of a property of interest of each binder may be measure with a CV of less than or equal to ten percent; in another embodiment, such factors are selected so that the values of the property of interest are measured with CVs of less than or equal to five percent; in still other embodiments, such factors are selected so that values are measured with CVs of less than or equal to two percent. In some embodiments, focused libraries are obtained by varying amino acids in a limited number of locations one or two at a time within a pre-existing binding compound, which may be the same as, or equivalent to, a reference binding compound. Preferably amino acids are varied at different positions one at a time. This is especially useful when an amino acid residue critical for binding is sought to be determined. Thus, for example, members of a library of candidate binding compounds may have nucleotide sequences identical to that encoding the pre-existing binding compound except for a single codon position. At that position, each member will have at least one codon different (and non-synonomous) from that of the pre-existing binding compound.

Such libraries may include members having an amino acid deletion at such location and may not necessarily include members with every possible codon at such location. Libraries may contain members corresponding to such substitutions (and deletions) at each of a set of amino acid locations within the pre-existing binding compound. The locations may be contiguous or non-contiguous. In some embodiments, the number of locations, or predetermined sites, where codons are varied are in the range of from 1 to 500; in another aspect, the number of such locations are in the range of from 1 to 250; in other embodiments, the number of such locations are in the range of from 10 to 100; and in still other embodiments, the number of such locations are in the range of from 10 to 250. A pre-existing binding compound may be any pre-existing antibody for which sequence information is available (or can be obtained). Typically, a pre-existing binding compound is a commercially important binding compound, such as an antibody drug, for which one desires to modify one or more properties, such as solubility, immunogenicity, reduction of cross reactivity, increase in stability, aggregation resistance, or the like, as discussed above.

In one embodiment, the locations where codons are varied comprise the V_{H} and V_{L} regions of the antibody, including both codons in framework regions and in CDRs; in another embodiment, the locations where codons are varied comprise the CDRs of the heavy and light chains of the antibody, or a subset of such CDRs, such as solely CDR1, solely CDR2, solely CDR3, or pairs thereof. In another embodiment, locations where codons are varied occur solely in framework regions; for example, a library of the invention may comprise single codon changes solely from a reference binding compound solely in framework regions of both V_{H} and V_{L} numbering in the range of from 10 to 250. In another embodiment, the locations where codons are varied comprise the CDR3s of the heavy and light chains of the antibody, or a subset of such CDR3s. In another embodiment, the number of locations where codons of V_{H} and V_{L} encoding regions are varied are in the range of from 10 to 250, such that up to 100 locations are in framework regions. In another embodiment, nucleic acid encoded binding compounds are derived from a pre-existing binding compound, such as a pre-existing antibody. Exemplary pre-existing binding compounds include, but are not limited to, antibody-targeted drugs or antibody-based drugs such as adalimumab (Humira), bevacizumab (Avastin), cetuximab (Erbitux), efalizumab (Raptiva), infliximab (Remicade), panitumumab (Vectubix), ranibuzumab (Lucentis), rituximab (Rituxan), trastuzumab (Herceptin), and the like.

In some embodiments, the above codon substitutions are generated by synthesizing coding segments with degenerate codons, e.g. inserting one or more “NNN” codons. The coding segments are then ligated into a vector, such as a replicative form of a phage, to form a library. Many different degenerate codons may be used with the present invention, such as the exemplary condons shown in Table I.

TABLE I
Exemplary Degenerate Codons

| Codon* | Description | Stop Codons | Number |
|---|---|---|---|
| NNN | All 20 amino acids | TAA, TAG, TGA | 64 |
| NNK or NNS | All 20 amino acids | TAG | 32 |
| NNC | 15 amino acids | none | 16 |
| NWW | Charged, hydrophobic | TAA | 16 |
| RVK | Charged, hydrophilic | none | 12 |
| DVT | Hydrophilic | none | 9 |
| NVT | Charged, hydrophilic | none | 12 |
| NNT | Mixed | none | 16 |
| VVC | Hydrophilic | none | 9 |
| NTT | Hydrophobic | none | 4 |
| RST | Small side chains | none | 4 |
| TDK | Hydrophobic | TAG | 6 |

*Symbols follow the IUB code: N = G/A/T/C, K = G/T, S = G/C, W = A/T, R = A/G, V = G/A/C, and D = G/A/T.

In some embodiments, the size of binding compound libraries used in the invention varies from about 1000 members to about 1×10⁵ members; in another aspect, the size of libraries used in the invention varies from about 1000 members to about 5×10⁴ members; and in further embodiments, the size of libraries used in the invention varies from about 2000 members to about 2.5×10⁴ members. Thus, nucleic acid libraries encoding such binding compound libraries would have sizes in ranges with upper and lower bounds up to 64 times the numbers recited above.

### Nucleic Acid Sequencing Techniques

As mentioned above, a variety of DNA sequence analyzers are available commercially to determine the nucleotide sequences of binder and non-binders in accordance with the invention. Commercial suppliers include, but are not limited to, 454 Life Sciences, Helicos, Life Technologies Corp., Illumina, Inc. (which produces sequencing instruments using Solexa-based sequencing techniques), Pacific Biosciences, and the like. Also, DNA sequencing techniques under commercial development may be used for implementing the invention, e.g. techniques disclosed in the following references, which are incorporated by reference: Rothberg et al, Nature, 475: 348-352 (2011); Rothberg et al, U.S. patent publication 2009/0026082; Anderson et al, Sensors and Actuators B Chem., 129: 79-86 (2008); Pourmand et al, Proc. Natl. Acad. Sci., 103: 6466-6470 (2006); Rothberg et al, U.S. patent publication 2010/0137143; Meller et al, U.S. patent publication 2009/0029477; and the like. The use of particular types DNA sequence analyzers is a matter of design choice, where a particular analyzer type may have performance characteristics (e.g. long read lengths, high number of reads, short run time, cost, etc.) that are particularly suitable for the experimental circumstances and binding compounds being analyzed. DNA sequence analyzers and their underlying chemistries have been reviewed in the following references, which are incorporated by reference for their guidance in selecting DNA sequence analyzers: Bentley et al, Nature, 456: 53-59 (2008)(describing Solexa-based sequencing); Kircher et al, Bioassays, 32: 524-536 (2010); Shendure et al, Science, 309: 1728-1732 (2005); Margulies et al, Nature, 437: 376-380 (2005); Metzker, Nature Reviews Genetics, 11: 31-46 (2010); Hert et al, Electrophoresis, 29: 4618-4626 (2008); Anderson et al, Genes, 1: 38-69 (2010); Fuller et al, Nature Biotechnology, 27: 1013-1023 (2009); and the like. Generally, nucleic acids of binding compounds are extracted and prepared for sequencing in accordance with instructions of a DNA sequence analyzer's instructions.

### Example

### Construction of an Avastin-Based Binding Compound Library

Listed below are the sequences of the heavy chain variable region and the light chain variable region of the humanized antibody Avastin (bevacizumab), Presta et al, Cancer Research, 57: 4593-4599 (1997). Together these two proteins form the high affinity binding site for VEGF that gives Avastin its efficacy against many solid tumors. It is known from structural studies on this and many other antibodies that the key amino acids involved in physically binding its ligand, VEGF, are located within the “CDR” regions highlighted by underlining.

To gain a complete functional map of all the possible single amino acid substitutions in the binding site of Avastin, two libraries of variant molecules need to be constructed. A complete single amino substitution library of the Avastin heavy chain will include 820 proteins (41 positions×20 amino acids). A complete single amino substitution library of the Avastin light chain will include 540 proteins (27 positions×20 amino acids). Each of these libraries may be constructed in a number of ways, including the use of oligonucleotide-directed mutagenesis to create pools of variant molecules that each carry a randomization codon (NNN) at a different position within the CDR sequences. In this example the Avastin heavy chain library would be composed of 41 pools of genes each containing a randomization codon (NNN) at a different position in the Avastin heavy chain CDRs. This would yield a redundant library of 2624 genes (41 positions×64 codons) for the heavy chain library. These 41 pools of sequences containing 2624 V_{H} genes each differing from the parent by at most by a single codon can be cloned into a standard phagemid display vector either as a Fabs or single-chain Fv's in conjunction with the wild type light chain. (Note that each pool contains a member that is wild type and numerous silent wild type variants also exist within the larger population). Likewise the 27 pools of Avastin V_{L} genes containing 1728 members each differing from the parent by at most one codon can be cloned into the same vector in conjunction with the wild type heavy chain gene to create the Avastin light chain library.

Once created and confirmed, these two libraries can be transformed into an appropriate bacterial strain to create stably transformed bacterial cell libraries. In this situation each antibody variant is carried in a separate bacterial cell. These two populations of cells can then be induced to produce phage particles by infecting them with a helper phage. The helper phage carries the phage genes that are missing in the phagemid and allows the cells to start producing one type of phage per cell. Infecting a population of cells carrying the full spectrum of single amino acid variants will produce a full spectrum of phage each carrying a variant Fab or scFv at its tail which was encoded by the single stranded DNA in its attached genome. The two libraries can then be harvested and used in two ways. First their diversity can be efficiently characterized using a massively parallel fragment sequencer (454, Illumina, ABI) to make sure that full spectrum libraries have been created. Next the libraries can be titred and set up in equilibrium binding assays with several concentrations of the VEGF ligand fused to a tag useful for immunoprecipitation (i.e. Fc-fusion). For maximum resolution the differing concentrations of the ligand should center around the K_{D} of the parent antibody and should vary in 2-10 fold increments. Care must be taken to scale the reactions to assure that the antigen is in large excess, so its free concentration will not be reduced during the binding reaction. These reactions are incubated until equilibrium is reached (for example, 22° C. for 24 hr in conventional binding reaction mixture). Once equilibrium has been reached, the two types of phage can be separated. The phage that are bound to the soluble antigen can be immunoprecipitated using a reagent that is specific for the ligand fusion, like protein A or an anti-Fc antibody. The unbound phage can then be isolated from the depleted supernatant from each reaction, e.g. by precipitating unbound binding-compound-expressing phage with anti-kappa chain antibody, anti-lambda chain antibody, anti-C_{H}1 antibody, anti-tag antibody, such as a myc tag, polyhistidine tag, or the like. Specifically, in one embodiment, human Fab-bearing phage may be isolated either by binding goat anti-kappa chain antibody followed by capture with protein G coated beads, or by binding biotinylated anti-kappa chain antibody followed by capture with streptavidin-coated beads. Alternatively to the above, binders and non-binders may be identified in a competitive binding reaction where, for example, library binding compounds compete with a reference binding compound for binding to an immobilized antigen, either by displacing previously bound reference compound or by being combined with antigen and reference compound at the same time. Guidance for carrying out such reactions is found in Wild, editor, The Immunoassay Handbook, 3^{rd} Edition (Elsevier, 2008), and like references. The V-region segments from all of the variants from the two samples from each reaction can then be amplified via PCR to serve as substrates for one of the massively parallel fragment sequencing platforms. Using the Illumina sequencer as an example, the bound and the free fractions from a single binding reaction of the Avastin heavy chain library would be sequenced in individual lanes of a flow cell. Each lane should yield between 10 and 30 million V-region sequences. Thus each of the 2641 genes in the Avastin library would be sequenced an average of 10,000 times between the two lanes. This is a very large number indicating that multiple reactions could be looked at simultaneously given a proper indexing scheme. Numbers for each clone from each lane of the flow cell can be tabulated and the two data sets can be combined to calculate percentage binding for each gene. These percentages can then be used to accurately rank the affinities of all of the genes in the library. As mentioned earlier there are two types of wild-type genes in the library: true wild types and silent mutations of wild-type. In some CDR sequencing schemes, only the latter will be available for use as internal standards, since wild-type CDRs dominate each library. This data can then be used to create an engineering heat map describing the effect of every possible mutation in the binding site and its effect on the protein's binding affinity for its ligand. This data can further be compiled into a plasticity map that codes each amino acid in the binding site for its ability to be changed without reducing the protein's binding affinity. Each amino acid that is actually playing an important role in the binding reaction will be highly intolerant to change, whereas amino acid positions that are not involved in the binding reaction should be much more tolerant to change.

Avastin V_{H}
(SEQ ID NO: 1)
EVQLVESGGGLVQPGGSLRLSCAASGYTFTNYGMNWVRQAPGKGLEWVGWINTYTGEPTY
AADFKRRFTFSLDTSKSTAYLQMNSLRAEDTAVYYCAKYPHYYGSSHWYFDVWGQGTLVT
VSSASTKGPSVFPLAPSSKSTSGGTAALGCLVKDYFPEPVTVSWNSGALTSGVHTFPAVL
QSSGLYSLSSVVTVPSSSLGTQTYICNVNHKPSNTKVDKKVEPKSCDKTHT
Avastin V_{L}
(SEQ ID NO: 2)
DIQMTQSPSSLSASVGDRVTITCSASQDISNYLNWYQQKPGKAPKVLIYFTSSLHSGVPS
RFSGSGSGTDFTLTISSLQPEDFATYYCQQYSTVPWTFGQGTKVEIKRTVAAPSVFIFPP
SDEQLKSGTASVVCLLNNFYPREAKVQWKVDNALQSGNSQESVTEQDSKDSTYSLSSTLT
LSKADYEKHKVYACEVTHQGLSSPVTKSFNRGEC

A library of such Avastin-based binding compounds was constructed as follows. Prior to inserting a mixture of synthetic segments to create a phagemid library, two phagemids were constructed with similar structures to the pHEN1 phagemid disclosed by Hoogenboom et al (cited above). Each of the phagemids includes a sequence that encodes an Fab fragment; however, one phagemid is engineered to accept variable light chain encoding sequences with a wild type heavy chain (i.e. the light chain library) and the other phagemid is engineered to accept variable heavy chain encoding sequences with a wild type light chain (i.e. the heavy chain library). The starting phagemid for both constructs was a pBCSK⁺ (Stratagene, San Diego, Calif.). Since the phagemids are grown in a conventional f⁺ E. coli host (XL1Blue, Stratagene), a bacterial leader sequence (MKYLLPTAAAGLLLLAAQPAMA (SEQ ID NO: 3)) was added to each of the above sequences for the Avastin V_{H} and V_{L} regions. In addition, the following ribosome binding site sequences were appended to the 5′ ends of the nucleotide sequences encoding the VH and VL regions: CTAGTTAATTAAaggaggageaggg (SEQ ID NO: 4) for the light chain (designated Fab-12 LC) and CTAGGCGGCCGCaggaggagcaggg (SEQ ID NO: 5) for the heavy chain (designated Fab-12 HC). The Lac promoter and polylinker elements of the pBCSK vector were rearranged and gene III was inserted, after which the light and heavy chain encoding regions were inserted in several steps to give a construct pBD4 (500), illustrated in FIG. 5 for the phagemid encoding the wild type Fab. Codons for the Fab regions were selected for expression in the E. coli host. The light chain library is constructed from the appropriate phagemid by swapping in the synthetic light chain library polynucleotides to a Pac I-Not I segment engineered into the construct. Likewise, the heavy chain library is constructed from the appropriate phagemid by swapping in the synthetic heavy chain library polynucleotides into a Not I-Xba I segment engineered into the construct. The resulting phagemid (500) for the heavy chain library has in sequence Lac promoter (502), and segments encoding the wild type light chain variable region (504), light chain constant region (506), heavy chain variable region (508), heavy chain constant region (510) and gene III fusion partner (512). Library sequences are expressed by infecting the host carrying the phagemids with a conventional helper phage (e.g. M13K07, New England Biolabs).

While the present invention has been described with reference to several particular example embodiments, those skilled in the art will recognize that many changes may be made thereto without departing from the spirit and scope of the present invention. The present invention is applicable to a variety of sensor implementations and other subject matter, in addition to those discussed above.

### DEFINITIONS

Unless otherwise specifically defined herein, terms and symbols of nucleic acid chemistry, biochemistry, genetics, and molecular biology used herein follow those of standard treatises and texts in the field, e.g. Kornberg and Baker, DNA Replication, Second Edition (W.H. Freeman, New York, 1992); Lehninger, Biochemistry, Second Edition (Worth Publishers, New York, 1975); Strachan and Read, Human Molecular Genetics, Second Edition (Wiley-Liss, New York, 1999); Abbas et al, Cellular and Molecular Immunology, edition (Saunders, 2007).

“Antibody” or “immunoglobulin” means a protein, either natural or synthetically produced by recombinant or chemical means, that structurally is a member of immunoglobulin superfamily (although it may not be of natural origin) and that is capable of specifically binding to a particular antigen or antigenic determinant, which may be a target molecule as the term is used herein. Antibodies, e.g. IgG antibodies, are usually heterotetrameric glycoproteins of about 150,000 daltons, composed of two identical light (L) chains and two identical heavy (H) chains, as illustrated in FIG. 3. Each light chain is linked to a heavy chain by one covalent disulfide bond, while the number of disulfide linkages varies between the heavy chains of different immunoglobulin isotypes. Each heavy and light chain also has regularly spaced intra-chain disulfide bridges. Each heavy chain has at one end a variable domain (V_{H}) followed by a number of constant domains. Each light chain has a variable domain at one end (V_{L}) and a constant domain at its other end; the constant domain of the light chain is aligned with the first constant domain of the heavy chain, and the light chain variable domain is aligned with the variable domain of the heavy chain, as illustrated in FIG. 3. Typically the binding characteristics, e.g. specificity, affinity, and the like, of an antibody, or a binding compound derived from an antibody, are determined by amino acid residues in the V_{H} and V_{L} regions, and especially in the CDR subregions of the V_{H} and V_{L} regions. The constant domains are not involved directly in binding an antibody to an antigen. Depending on the amino acid sequence of the constant domain of their heavy chains, immunoglobulins can be assigned to different classes. There are five major classes of immunoglobulins: IgA, IgD, IgE, IgG, and IgM, and several of these can be further divided into subclasses (isotypes), e.g., IgG, IgG₂, IgG₃, IgG₄, IgA₁, and IgA₂. “Antibody fragment”, and all grammatical variants thereof, as used herein are defined as a portion of an intact antibody comprising the antigen binding site or variable region of the intact antibody, wherein the portion is free of the constant heavy chain domains (i.e. CH2, CH3, and CH4, depending on antibody isotype) of the Fc region of the intact antibody. Examples of antibody fragments include Fab, Fab′, Fab′-SH, F(ab′)₂, and Fv fragments; diabodies; any antibody fragment that is a polypeptide having a primary structure consisting of one uninterrupted sequence of contiguous amino acid residues (referred to herein as a “single-chain antibody fragment” or “single chain polypeptide”), including without limitation (1) single-chain Fv (scFv) molecules (2) single chain polypeptides containing only one light chain variable domain, or a fragment thereof that contains the three CDRs of the light chain variable domain, without an associated heavy chain moiety and (3) single chain polypeptides containing only one heavy chain variable region, or a fragment thereof containing the three CDRs of the heavy chain variable region, without an associated light chain moiety; and multispecific or multivalent structures formed from antibody fragments. The term “monoclonal antibody” (mAb) as used herein refers to an antibody obtained from a population of substantially homogeneous antibodies, i.e., the individual antibodies comprising the population are identical except for possible naturally occurring mutations that may be present in minor amounts. Monoclonal antibodies are highly specific, being directed against a single antigenic site. Furthermore, in contrast to conventional (polyclonal) antibody preparations which typically include different antibodies directed against different determinants (epitopes), each mAb is directed against a single determinant on the antigen.

“Binding compound” means a compound that is capable of specifically binding to a particular target molecule or group of target molecules. Examples of binding compounds include antibodies, receptors, transcription factors, signaling molecules, viral proteins, lectins, nucleic acids, aptamers, and the like, e.g. Sharon and L is, Lectins, 2^{nd} Edition (Springer, 2006); Klussmann, The Aptamer Handbook: Functional Oligonucleotides and Their Applications (John Wiley & Sons, New York, 2006). In one aspect, binding compounds are proteins, such as antibodies or fragments thereof, receptors, signaling proteins, or the like. Mutants of protein binding compounds, sometimes referred to herein as “binding compound mutants,” “library variants,” or the like, are protein binding compounds that differ from a reference binding compound by one or more amino acid substitutions; in one aspect, each binding compound mutant differs from a reference binding compound by from 1 to 3 amino acid substitutions; and in a further aspect, each binding compound mutant differs from a reference binding compound by one amino acid substitution. As used herein, “antibody-based binding compound” or equivalently “antibody binding compound” means a binding compound derived from an antibody, such as an antibody fragment, including but not limited to, Fab, Fab′, F(ab′)₂, and Fv fragments, or recombinant forms thereof. In one aspect, an antibody-based binding compound comprises a scaffold or framework region of an antibody and CDR regions of an antibody. In some embodiments, the binding characteristics of a antibody binding compound (e.g. affinity, specificity, etc.) are determined by such framework and CDR regions and such structures may be expression in various formats, that is, various antibody fragment types and various isotypes.

“Complementary-determining region” or “CDR” means a short sequence (up to 13 to 18 amino acids) in the variable domains of immunoglobulins. The CDRs (six of which are present in IgG molecules) are the most variable part of immunoglobulins and contribute to their diversity by making specific contacts with a specific antigen, allowing immunoglobulins to recognize a vast repertoire of antigens with a high affinity, e.g. Beck et al, Nature. Reviews Immunology, 10: 345-352 (2010).

“Complex” as used herein means an assemblage or aggregate of molecules in direct or indirect contact with one another. In one aspect, “contact,” or more particularly, “direct contact” in reference to a complex of molecules, or in reference to specificity or specific binding, means two or more molecules are close enough so that attractive noncovalent interactions, such as Van der Waal forces, hydrogen bonding, ionic and hydrophobic interactions, and the like, dominate the interaction of the molecules. In such an aspect, a complex of molecules is stable in that under assay conditions, the presence of the complex is thermodynamically favorable. As used herein, “complex” may refer to a stable aggregate of two or more proteins, which is equivalently referred to as a “protein-protein complex.” A complex may also refer to an antibody bound to its corresponding antigen. Complexes of particular interest in the invention are protein-protein complexes and antibody-antigen complexes. As noted above, various types of noncovalent interactions may contribute to antibody binding of antigen, including electrostatic forces, hydrogen bonds, van der Waals forces, and hydrophobic interactions. The relative importance of each of these depends on the structures of the binding site of the individual antibody and of the antigenic determinant. The strength of the binding between a single combining site of an antibody and an epitope of an antigen, which can be determined experimentally by equilibrium dialysis (e.g. Abbas et al (cited above)), is called the affinity of the antibody. The affinity is commonly represented by a dissociation constant (K_{d}), which describes the concentration of antigen that is required to occupy the combining sites of half the antibody molecules present in a solution of antibody. A smaller K_{d} indicates a stronger or higher affinity interaction, because a lower concentration of antigen is needed to occupy the sites. For antibodies specific for natural antigens, the K_{d} usually varies from about 10⁻⁷ M to 10⁻¹¹ M. Serum from an immunized individual will contain a mixture of antibodies with different affinities for the antigen, depending primarily on the amino acid sequences of the CDRs.

“Expression” means the process by which a polypeptide or protein is made using information encoded in a gene or nucleic acid. In one aspect, “expression” means the production of a polypeptide or protein by biological processes that use information encoded in a gene or nucleic acid in accordance with the genetic code. Such biological processes include transcription and translation and are usually carried out in a host organism, or expression host. “Expression system” refers to combinations of expression hosts and expression vectors used with such hosts. A polypeptide or protein produced by an expression system may or may not have a biological function, e.g. binding activity for a target, enzymatic activity, or the like. Expression systems for antibody binding compounds and antibody fragments are well-known in the art, as evidenced by the following references which are incorporated by reference: U.S. Pat. Nos. 7,452,975; 7,892,550; 8,030,023; 6,787,637; 7,329,405; 7,910,104; 7,807,163; 7,947,495; and U.S. patent publication 2010/0322931; and the like.

“Flow system” or “flow cytometer” means any instrument or device (i) that is capable of constraining particles or cells to move in a collinear path in a fluid stream by or through one or more detection stations which collect multiparameter data related to the particles or cells and (ii) that is capable of enumerating or sorting such particles based on the collected multiparameter data. Flow systems have a wide variety of forms and use a wide variety of techniques to achieve such functions, as exemplified by the following references that are incorporated by reference Shapiro, Practical Flow Cytometry, Fourth Edition (Wiley-Liss, 2003), Bonner et al, Rev Sci Instruments, 43 404 (1972), Huh et al, Physiol Meas, 26 R73-98 (2005), Ateya et al, Anal Bioanal Chem, 391 1485-1498 (2008), Bohm et al, U.S. Pat. No. 7,157,274; Wang et al, U.S. Pat. No. 7,068,874, and the like. Flow systems may comprise fluidics systems having components wherein a sample fluid stream is inserted into a sheath fluid stream so that particles or cells in the sample fluid are constrained to move in a collinear path, which may take place in a cuvette, other chamber that serves as a detection station, or in a nozzle or other structure, for creating a stream-in-air jet, which may then be manipulated electrically, e.g. as with fluorescence-activated cell sorting (FACS) instruments. Flow systems, flow cytometers, and flow sorters and common applications thereof are disclosed in one or more of the following references, which are incorporated by reference: Robinson et al (Editors) Current Protocols in Cytometry (John Wiley & Sons, 2007); Shapiro, Practical Flow Cytometry, Fourth Edition (Wiley-Liss, 2003); Owens et al (Editors), Flow Cytometry Principles for Clinical Laboratory Practice: Quality Assurance for Quantitative Immunophenotyping (Wiley-Liss, 1994); Ormerod (Editor) Flow Cytometry: A Practical Approach (Oxford University Press, 2000); and the like.

“Ligand” means a compound that binds specifically and reversibly to another chemical entity to form a complex. Ligands include, but are not limited to, small organic molecules, peptides, proteins, nucleic acids, and the like. Of particular interest are protein-ligand complexes, which include protein-protein complexes, antibody-antigen complexes, enzyme-substrate complexes, and the like.

“Phage display” is a technique by which variant polypeptides are displayed as fusion proteins to at least a portion of a coat protein on the surface of phage, e.g., filamentous phage, particles. A utility of phage display lies in the fact that large libraries of randomized protein variants can be rapidly and efficiently selected for those sequences that bind to a target molecule with high affinity. Display of peptide and protein libraries on phage has been used for screening millions of polypeptides for ones with specific binding properties. Polyvalent phage display methods have been used for displaying small random peptides and small proteins through fusions to either gene III or gene VIII of filamentous phage. Wells and Lowman, Curr. Opin. Struct. Biol., 3:355-362 (1992), and references cited therein. In monovalent phage display, a protein or peptide library is fused to a gene III or a portion thereof, and expressed at low levels in the presence of wild type gene III protein so that phage particles display one copy or none of the fusion proteins. Avidity effects are reduced relative to polyvalent phage so that selection is on the basis of intrinsic ligand affinity, and phagemid vectors are used, which simplify DNA manipulations. Lowman and Wells, Methods: A companion to Methods in Enzymology 3:205-0216 (1991).

“Phagemid” means a plasmid vector having a bacterial origin of replication, e.g., Co1E1, and a copy of an intergenic region of a bacteriophage. The phagemid may be used on any known bacteriophage, including filamentous bacteriophage and lambdoid bacteriophage. The plasmid will also generally contain a selectable marker for antibiotic resistance. Segments of DNA cloned into these vectors can be propagated as plasmids. When cells harboring these vectors are provided with all genes necessary for the production of phage particles, the mode of replication of the plasmid changes to rolling circle replication to generate copies of one strand of the plasmid DNA and package phage particles. The phagemid may form infectious or non-infectious phage particles. This term includes phagemids, which contain a phage coat protein gene or fragment thereof linked to a heterologous polypeptide gene as a gene fusion such that the heterologous polypeptide is displayed on the surface of the phage particle.

“Phage vector” means a double stranded replicative form of a bacteriophage containing a heterologous gene and which is capable of replication. The phage vector has a phage origin of replication allowing phage replication and phage particle formation. The phage is preferably a filamentous bacteriophage, such as an M13, f1, fd, Pf3 phage or a derivative thereof, or a lambdoid phage, such as lambda, 21, phi80, phi81, 82, 424, 434, etc., or a derivative thereof. The term “phage” may be used in reference to a single stranded form or a double stranded form which from the context will be clear to one of ordinary skill.

“Primer” means an oligonucleotide, either natural or synthetic that is capable, upon forming a duplex with a polynucleotide template, of acting as a point of initiation of nucleic acid synthesis and being extended from its 3′ end along the template so that an extended duplex is formed. Extension of a primer is usually carried out with a nucleic acid polymerase, such as a DNA or RNA polymerase. The sequence of nucleotides added in the extension process is determined by the sequence of the template polynucleotide. Usually primers are extended by a DNA polymerase. Primers usually have a length in the range of from 14 to 40 nucleotides, or in the range of from 18 to 36 nucleotides. Primers are employed in a variety of nucleic amplification reactions, for example, linear amplification reactions using a single primer, or polymerase chain reactions, employing two or more primers. Guidance for selecting the lengths and sequences of primers for particular applications is well known to those of ordinary skill in the art, as evidenced by the following references that are incorporated by reference: Dieffenbach, editor, PCR Primer: A Laboratory Manual, 2^{nd} Edition (Cold Spring Harbor Press, New York, 2003). “Polypeptide” refers to a class of compounds composed of amino acid residues chemically bonded together by amide linkages with elimination of water between the carboxy group of one amino acid and the amino group of another amino acid. A polypeptide is a polymer of amino acid residues, which may contain a large number of such residues. Peptides are similar to polypeptides, except that, generally, they are comprised of a lesser number of amino acids. Peptides are sometimes referred to as oligopeptidcs. There is no clear-cut distinction between polypeptides and peptides. For convenience, in this disclosure and claims, the term “polypeptide” will be used to refer generally to peptides and polypeptides. The amino acid residues may be natural or synthetic. “Protein” refers to a polypeptide, usually synthesized by a biological cell, folded into a defined three-dimensional structure. Proteins are generally from about 5,000 to about 5,000,000 daltons or more in molecular weight, more usually from about 5,000 to about 1,000,000 molecular weight, and may include posttranslational modifications, such acetylation, acylation, ADP-ribosylation, amidation, disulfide bond formation, farnesylation, demethylation, formation of covalent cross-links, formation of cystine, glycosylation, hydroxylation, iodination, methylation, myristoylation, oxidation, phosphorylation, prenylation, selenoylation, sulfation, and ubiquitination, e.g. Wold, F., Post-translational Protein Modifications: Perspectives and Prospects, pgs. 1-12 in Post-translational Covalent Modification of Proteins, B. C. Johnson, Ed., Academic Press, New York, 1983. Proteins include, by way of illustration and not limitation, cytokines or interleukins, enzymes such as, e.g., kinases, proteases, galactosidases and so forth, protamines, histones, albumins, immunoglobulins, scleroproteins, phosphoproteins, mucoproteins, chromoproteins, lipoproteins, nucleoproteins, glycoproteins, T-cell receptors, proteoglycans, and the like.

“Specific” or “specificity” in reference to the binding of one molecule to another molecule, such as a labeled target sequence for a probe, means the recognition, contact, and formation of a stable complex between the two molecules, together with substantially less recognition, contact, or complex formation of that molecule with other molecules. In one aspect, “specific” in reference to the binding of a first molecule to a second molecule means that to the extent the first molecule recognizes and forms a complex with another molecule in a reaction or sample, it forms the largest number of the complexes with the second molecule. Preferably, this largest number is at least fifty percent. Generally, molecules involved in a specific binding event have areas on their surfaces or in cavities giving rise to specific recognition between the molecules binding to each other. Examples of specific binding include antibody-antigen interactions, enzyme-substrate interactions, formation of duplexes or triplexes among polynucleotides and/or oligonucleotides, receptor-ligand interactions, and the like. As used herein, “contact” in reference to specificity or specific binding means two molecules are close enough that weak noncovalent chemical interactions, such as Van der Waal forces, hydrogen bonding, base-stacking interactions, ionic and hydrophobic interactions, and the like, dominate the interaction of the molecules.

“Wild type” or “reference” or “pre-existing” in reference to a binding compound are used synonymously to means a compound which is being analyzed or improved in accordance with the method of the invention. That is, such a compound serves as a starting material from which variant polypeptides are derived through the introduction of mutations. A “wild type” sequence for a given protein is usually the sequence that is most common in nature, but the term is used more broadly here to include compounds that have been engineered. Similarly, a “wild type” gene sequence is typically the sequence for that gene which is most commonly found in nature, but the usage here includes genes that may have been engineered from a natural compound, e.g. a gene which has been engineered to consist of bacterial codons even though it encodes a human protein. Mutations may be introduced into a “wild type” gene (and thus the protein it encodes) through any available process, e.g. site-specific mutation, insertion of chemically synthesized segments, or other conventional means. The products of such processes are “variant” or “mutant” forms of the original “wild type” protein or gene. Exemplary reference (or wild type or pre-existing) sequences include antibody-targeted drugs or antibody-based drugs such as adalimumab (Humira), bevacizumab (Avastin), cetuximab (Erbitux), efalizumab (Raptiva), infliximab (Remicade), panitumumab (Vectubix), ranibuzumab (Lucentis), rituximab (Rituxan), trastuzumab (Herceptin), and the like.

What is claimed is:

1. A method of determining binding compound mutants having increased expression in a host organism, the method comprising the steps of:
reacting under binding conditions one or more ligands with a library of binding compounds comprising a reference binding compound and mutants thereof, the reference binding compound and each mutant thereof being encoded by a nucleotide sequence;
determining the nucleotide sequences of binding compounds forming complexes with the one or more ligands to obtain a relative affinity for each such binding compound based on a number of nucleotide sequences enumerated for each such binding compound, respectively, wherein each such relative affinity has a coefficient of variation of ten percent or less;
measuring expression of an internal standard and a binding compound of the library on surfaces of host organisms so that expression of each binding compound can be compared to that of the internal standard;
determining the nucleotide sequences of binding compounds being expressed on the surface of the host organism at a higher level than that of the reference binding compound; and
selecting mutants of the reference binding compound that have a relative affinity equal to or greater than that of the reference binding compound and an expression level in the host organism greater than that of the reference binding compound.

2. The method of claim 1 wherein said host organism is selected from the group consisting of mammalian cells, yeast cells, insect cells, and bacterial cells.

3. The method of claim 2 wherein said step of determining said nucleotide sequences to obtain said relative affinity further includes expressing said binding compounds in a phage display system.

4. The method of claim 3 wherein said step of measuring expression of said library of said binding compounds further includes providing said library of binding compounds in an immunoglobulin G format.

5. The method of claim 4 wherein each of said library variants and said internal standard have a transmembrane region and such transmembrane region is the same for said library variants and said internal standard.

6. The method of claim 5 wherein said host organism is a mammalian cell and wherein said step of measuring expression of said library of said binding compounds includes expressing said binding compounds using a stable episomal vector.

7. The method of claim 5 wherein said host organism is a mammalian cell and wherein said step of measuring expression of said library of said binding compounds includes expressing said binding compounds using a transient episomal vector.

8. The method of claim 3 wherein said host organism comprises bacterial cells.

9. The method of claim 3 wherein said host organism comprises yeast cells.

10. The method of claim 3 wherein said step of selecting includes isolating said mutants using a flow system.

11. The method of claim 3 further including the steps of:
treating said library with a destabilizing agent to form a treated library; and
reacting under binding conditions the one or more ligands with the treated library and determining the nucleotide sequences of binding compounds forming complexes with the one or more ligands to obtain a relative affinity for each thereof based on a number of nucleotide sequences enumerated for each such binding compound, respectively, each relative affinity having a coefficient of variation of ten percent or less; and
wherein said step of selecting mutants further includes selecting said mutants of the treated library that have a relative affinity equal to or greater than that of said reference binding compound in the treated library and said library that (i) have a relative affinity equal to or greater than that of said reference binding compound in said library and (ii) an expression level in the host organism greater than that of the reference binding compound.

12. The method of claim 3 wherein said step of determining said nucleotide sequences of binding compounds being expressed on said surface of said host organism further includes obtaining an expression level for each such binding compound based on a number of nucleotide sequences enumerated for each such binding compound, respectively, wherein each such expression level has a coefficient of variation of ten percent or less.

13. The method of claim 1 wherein said nucleotide sequences encoding said mutants of said reference binding compound have at predetermined sites a degenerate codon that includes synonymous codons and wherein said coefficients of variation of each of said relative affinities is determined from the coefficient of variation of among numbers of nucleotide sequences encoding the same mutant and containing different synonymous codons.

14. A method of determining binding compound mutants having increased stability and expression in a host organism, the method comprising the steps of:
reacting under binding conditions one or more ligands with an untreated library of binding compounds comprising a reference binding compound and mutants thereof, the reference binding compound and each mutant thereof being encoded by a nucleotide sequence;
determining the nucleotide sequences of binding compounds forming complexes with the one or more ligands to obtain a relative affinity for each thereof based on a number of nucleotide sequences enumerated for each such binding compound, respectively, each relative affinity having a coefficient of variation of ten percent or less;
treating the untreated library with a destabilizing agent to form a treated library;
reacting under binding conditions the one or more ligands with the treated library and determining the nucleotide sequences of binding compounds forming complexes with the one or more ligands to obtain a relative affinity for each thereof based on a number of nucleotide sequences enumerated for each such binding compound, respectively, each relative affinity having a coefficient of variation of ten percent or less;
measuring expression of an internal standard and each of the library of binding compounds on a surface of a host organism so that expression of each binding compound can be compared to that of the internal standard;
determining the nucleotide sequences of binding compounds being expressed on the surface of the host organism at a higher level than that of the reference binding compound; and
selecting mutants of the reference binding compound that have a relative affinity equal to or greater than that of the reference binding compound in the untreated library, an expression level in the host organism greater than that of the reference binding compound, and a relative affinity equal to or greater than that of the reference binding compound in the treated library.

15. The method of claim 12 wherein said host organism is selected from the group consisting of mammalian cells, yeast cells, insect cells and bacterial cells.

16. The method of claim 13 wherein said steps of determining said nucleotide sequences to obtain said relative affinities further includes expressing said binding compounds in a phage display system.

17. The method of claim 14 wherein said step of measuring expression of said library of said binding compounds further includes providing said library of binding compounds in an immunoglobulin G format.
